(19) United States
(12) Patent Application Publication
(10) Pub. No.: US 2026/0294701 A1
(43) Pub. Date: Oct. 1, 2026

(54) Folding Loading Systems For Patient Transport Apparatuses

(71) Applicant: Stryker Corporation, Portage, MI (US)

(72) Inventors: Brian J. Tessmer, Mattawan, MI (US); Jennifer Blowers, Richland, MI (US); Ciara Poolman, Kalamazoo, MI (US); Michael Noora, Schoolcraft, MI (US); Emily Wilborn, Pittsford, NY (US)

(73) Assignee: Stryker Corporation, Portage, MI (US)

(21) Appl. No.: 19/478,139

(22) PCT Filed: Apr. 26, 2024
(86) PCT No.: PCT/US2024/026390

§ 371 Date: Oct. 23, 2025

Related U.S. Application Data
(60) Provisional application No. 63/462,292, filed on Apr. 27, 2023.

(51) Int. Cl. A61G 3/06; A61G 5/04; A61G 5/08

(52) U.S. Cl. CPC A61G 3/061; A61G 5/041; A61G 5/047; A61G 5/08

(57) ABSTRACT

A loading device for supporting a patient transport apparatus in a transport vehicle. The loading device includes a storage frame coupled to the transport vehicle. The storage frame extends between a first end and a second end along a loading axis and have a loading surface. The loading device further includes a guide assembly coupled to the storage frame and arranged adjacent to the loading surface. The guide assembly includes a guide rail extending parallel to the loading axis and a trolley. The trolley is slidably coupled to the guide rail and movable between a raised configuration and a lowered configuration and is configured to releasably engage the patient transport apparatus. The loading device further includes a traction member coupled to the loading surface for engagement with a powered track assembly of the patient transport apparatus.

### CROSS-REFERENCE TO RELATED APPLICATION(S)

The subject patent application claims priority to and all the benefits of U.S. Provisional Patent Application No. 63/462,292 filed on Apr. 27, 2023, the disclosure of which is hereby incorporated by reference in its entirety.

### BACKGROUND

In many instances, patients with limited mobility may have difficulty traversing stairs without assistance. In certain emergency situations, traversing stairs may be the only viable option for exiting a building. In order for a caregiver to transport a patient along stairs in a safe and controlled manner, a stair chair or evacuation chair may be utilized. Stair chairs are adapted to transport seated patients either up or down stairs, with two caregivers typically supporting, stabilizing, or otherwise carrying the stair chair with the patient supported thereon.

The stair chair is generally transported inside an ambulance to the location of a patient. Within the ambulance, space is limited. Tightly packing all of the tools and supplies carried by an ambulance negatively impacts the time required to retrieve an item. An ambulance may have one or more exterior storage compartments that can be used to efficiently store that are only needed once the ambulance has arrived at the location of the patient. A loading system that overcomes the difficulty of loading a stair chair in a storage compartment with limited space is desirable.

### SUMMARY

The present disclosure provides a loading system for use with a transport vehicle. The loading system may include: a patient transport apparatus may include: a support structure, a seat section and a back section operatively attached to the support structure for supporting a patient during transport, a track assembly operatively attached to the support structure and including a movable belt for engaging stairs, where the track assembly is arranged for selective operation between a retracted position and a deployed position where the track assembly is arranged to engage stairs, and where the patient transport apparatus is operable between: a chair configuration where the track assembly is in the retracted position for supporting the patient transport apparatus for movement along floor surfaces, a stair configuration where the track assembly is in the deployed position for supporting the patient transport apparatus for movement along stairs, and a stowed configuration, a motor coupled to the support structure and operably coupled to the track assembly for operating the movable belt, and a battery coupled to the support structure and in electrical communication with the motor; and a loading device supported by the transport vehicle, the loading device may include: a storage frame extending between a first end and a second end along a loading axis and having a loading surface, a traction member arranged on the loading surface for engagement with the movable belt of the track assembly of the patient transport apparatus, and a guide assembly coupled to the storage frame and arranged for engagement with the patient transport apparatus in the stowed configuration adjacent to the second end of the storage frame, where engagement between the guide assembly and the patient transport apparatus urges the movable belt of the track assembly toward the traction member as the patient transport apparatus moves toward the first end of the storage frame in response to torque generated by the motor of the patient transport apparatus.

The present disclosure also provides a loading device for supporting a patient transport apparatus in a transport vehicle, the loading device may include: a storage frame coupled to the transport vehicle, the storage frame extending between a first end and a second end along a loading axis and having a loading surface; a guide assembly coupled to the storage frame and arranged adjacent to the loading surface, the guide assembly may include: a guide rail extending parallel to the loading axis; and a trolley slidably coupled to the guide rail and movable between a raised configuration and a lowered configuration, the trolley configured to releasably engage the patient transport apparatus; and a traction member coupled to the loading surface for engagement with a movable belt of a track assembly of the patient transport apparatus.

The present disclosure also provides a loading system including: a transport vehicle; a patient transport apparatus may include: a support structure, a seat section and a back section operatively attached to the support structure for supporting a patient during transport, a track assembly operatively attached to the support structure and including a movable belt for engaging stairs, where the track assembly is arranged for selective operation between a retracted position and a deployed position where the track assembly is arranged to engage stairs, and where the patient transport apparatus is operable between: a chair configuration where the track assembly is in the retracted position for supporting the patient transport apparatus for movement along floor surfaces, a stair configuration where the track assembly is in the deployed position for supporting the patient transport apparatus for movement along stairs, and a stowed configuration, a motor coupled to the support structure and operably coupled to the track assembly for operating the movable belt, and a battery coupled to the support structure and in electrical communication with the motor; and a loading device may include: a storage frame coupled to the transport vehicle and extending between a first end and a second end along a loading axis and having a loading surface; a guide assembly coupled to the storage frame and arranged adjacent to the loading surface, the guide assembly may include: a guide rail extending parallel to the loading axis; and a trolley slidably coupled to the guide rail and movable between a raised configuration and a lowered configuration, the trolley configured to releasably engage the patient transport apparatus in the stowed configuration; and a traction member coupled to the loading surface and arranged to engage the movable belt of the track assembly of the patient transport apparatus as the patient transport apparatus moves with the trolley toward the first end of the storage frame in response to torque generated by the motor of the patient transport apparatus.

The present disclosure also provides a loading system for use with a transport vehicle. The loading system may include: a patient transport apparatus may include a powered track assembly, the patient transport apparatus being operable between a chair configuration and a stowed configuration; a loading device supported by the transport vehicle, the loading device may include: a storage frame extending between a first end and a second end along a loading axis and having a loading surface; a traction member arranged on the loading surface for engagement with the powered track assembly of the patient transport apparatus; and a guide assembly coupled to the storage frame and arranged for engagement with the patient transport apparatus in the stowed configuration adjacent to the second end of the storage frame, where engagement between the guide assembly and the patient transport apparatus urges the powered track assembly toward the traction member as the patient transport apparatus moves toward the first end of the storage frame.

The present disclosure also provides a loading device for supporting a patient transport apparatus in a transport vehicle, the loading device may include: a storage frame coupled to the transport vehicle, the storage frame extending between a first end and a second end along a loading axis and having a loading surface; a guide assembly coupled to the storage frame and arranged adjacent to the loading surface, the guide assembly may include: a guide rail extending parallel to the loading axis; and a trolley slidably coupled to the guide rail and movable between a raised configuration and a lowered configuration, the trolley configured to releasably engage the patient transport apparatus; and a traction member coupled to the loading surface for engagement with a powered track assembly of the patient transport apparatus.

The present disclosure also provides a loading system including: a transport vehicle; a patient transport apparatus may include a powered track assembly, the patient transport apparatus being operable between a chair configuration and a stowed configuration; a loading device may include: a storage frame coupled to the transport vehicle and extending between a first end and a second end along a loading axis and having a loading surface; a guide assembly coupled to the storage frame and arranged adjacent to the loading surface, the guide assembly may include: a guide rail extending parallel to the loading axis; and a trolley slidably coupled to the guide rail and movable between a raised configuration and a lowered configuration, the trolley configured to releasably engage the patient transport apparatus in the stowed configuration; and a traction member coupled to the loading surface and configured for engagement with the powered track assembly of the patient transport apparatus.

Any of the above aspects can be combined in full or in part. Any features of the above aspects can be combined in full or in part. Any of the above implementations for any aspect can be combined with any other aspect. Any of the above implementations can be combined with any other implementation whether for the same aspect or a different aspect.

### BRIEF DESCRIPTION OF THE DRAWINGS

Advantages of the present disclosure will be readily appreciated as the same becomes better understood by reference to the following detailed description when considered in connection with the accompanying drawings.

FIG. 1 is an environmental view of a first exemplary transport vehicle having a first exterior cargo volume including a first implementation of a loading system for loading a powered patient transport apparatus into the first exterior cargo volume.

FIG. 2 is another environmental view of a second exemplary transport vehicle having a second exterior cargo volume including a second implementation of a loading system for loading a powered patient transport apparatus into the second exterior cargo volume.

FIG. 3 is yet another environmental view of a third exemplary transport vehicle having a cargo volume and further showing the loading system of FIG. 2.

FIG. 4 is a front perspective view of the powered patient transport apparatus of FIGS. 1-3, shown arranged in a stair configuration for supporting a patient for transport along stairs, and shown with a track assembly disposed in a deployed position, and with a handle assembly disposed in an extended position.

FIG. 5 is another front perspective view of the powered patient transport apparatus of FIG. 4, shown arranged in a chair configuration for supporting a patient for transport along a floor surface, and shown with a track assembly disposed in a retracted position, and with a handle assembly disposed in a collapsed position.

FIG. 6 is a rear perspective view of the powered patient transport apparatus of FIGS. 4 and 5, shown arranged in the stair configuration as depicted in FIG. 4, and shown having an extension lock mechanism, a folding lock mechanism, and a deployment lock mechanism.

FIG. 7 is a partial schematic view of a control system of the powered patient transport apparatus of FIGS. 4-6, shown with a controller disposed in communication with a battery, a user interface, and a drive system.

FIG. 8 is a right-side plan view of the powered patient transport apparatus of FIGS. 4-7, shown arranged in a stowed configuration maintained by the folding lock mechanism.

FIG. 9A is another right-side plan view of the powered patient transport apparatus arranged in the chair configuration and with the handle assembly in a collapsed position.

FIG. 9B is another right-side plan view of the powered patient transport apparatus arranged in the stair configuration and with the handle assembly in an intermediate position.

FIG. 9C is another right-side plan view of the powered patient transport apparatus arranged in the stair configuration and with the handle assembly in an extended position.

FIG. 10A is a partial rear perspective view of the powered patient transport apparatus of FIGS. 4-9C, shown arranged in the stowed configuration as depicted in FIG. 3, with the deployment lock mechanism shown retaining the track assembly in the retracted position.

FIG. 10B is another partial rear perspective view of the powered patient transport apparatus of FIG. 10A, shown arranged in the stowed configuration, with the deployment lock mechanism shown retaining the track assembly in the deployed position.

FIG. 11 is a rear view of the back side of the powered patient transport apparatus of FIG. 3 depicting the user interface.

FIG. 12A is a right-side plan view of the powered patient transport apparatus of FIG. 3, shown supporting a patient in the chair configuration on a floor surface adjacent to stairs, and shown with a first caregiver engaging a pivoting handle assembly.

FIG. 12B is another right-side plan view of the powered patient transport apparatus of FIG. 12A, shown with the first caregiver having engaged the deployment lock mechanism to move the track assembly out of the retracted position and a second caregiver engaging a front handle assembly in an extended position.

FIG. 12C is another right-side plan view of the powered patient transport apparatus of FIG. 12B, shown having moved towards the stairs for descent while supported by the first and second caregivers.

FIG. 12D is another right-side plan view of the powered patient transport apparatus of FIG. 12C, shown having moved initially down the stairs for descent to bring a belt of the track assembly into contact with the stairs while still supported by the first and second caregivers.

FIG. 12E is another right-side plan view of the powered patient transport apparatus of FIG. 12D, shown with the belt of the track assembly in contact with the stairs while still supported by the first and second caregivers.

FIG. 12F is another right-side plan view of the powered patient transport apparatus of FIG. 12E, shown with the belt of the track assembly in contact with the stairs while still supported by the first and second caregivers.

FIG. 13 is a close-up perspective view of the loading system showing a loading device having a storage frame and in a loading position, a pair of traction members, and a guide assembly.

FIG. 14 is a perspective view of the loading system of FIG. 13 and a patient transport apparatus in the stowed configuration and the loading device in a loading position.

FIG. 15 is a side view of the loading system and patient transport apparatus of FIG. 14 with the patient transport apparatus in an unloaded position and the loading device in a loading position.

FIG. 16 is a side view of the loading system and patient transport apparatus of FIG. 15 with the patient transport apparatus coupled to the loading device and in a lowered position and the loading device in a loading position.

FIG. 17 is a side view of the loading system and patient transport apparatus of FIG. 15 with the patient transport apparatus coupled to the loading system and in a raised position and the loading device in a storage position.

FIG. 18 is a close-up perspective view of the patient transport apparatus of FIG. 13 showing the guide assembly.

FIG. 19 is a close-up perspective view of the loading system of FIG. 1 showing a loading device having a storage frame, a pair of traction members, a pair of traction member extensions, and a guide assembly.

FIG. 20 is a perspective view of a loading system showing a loading device having a storage frame, a pair of traction members, and a second implementation of a guide assembly.

FIG. 21 is a cross-sectional view of the loading system of FIG. 20 shown with a patient transport apparatus coupled to the loading device and in a raised position and the loading device in a loading position.

FIG. 22 is a cross-sectional view of the loading system of FIG. 20 shown with a patient transport apparatus coupled to the loading device and in a raised position and the loading device in a storage position.

### DETAILED DESCRIPTION

Referring now to the drawings, wherein like numerals indicate like parts throughout the several views, the present disclosure is directed toward a loading system 400, which generally includes a patient transport apparatus 100 configured to allow one or more caregivers to transport a patient, and a loading device 402 to load the patient transport apparatus 100 into and unload the patient transport apparatus from a transport vehicle 50 (e.g., an ambulance) for storage and transport, as described in greater detail below.

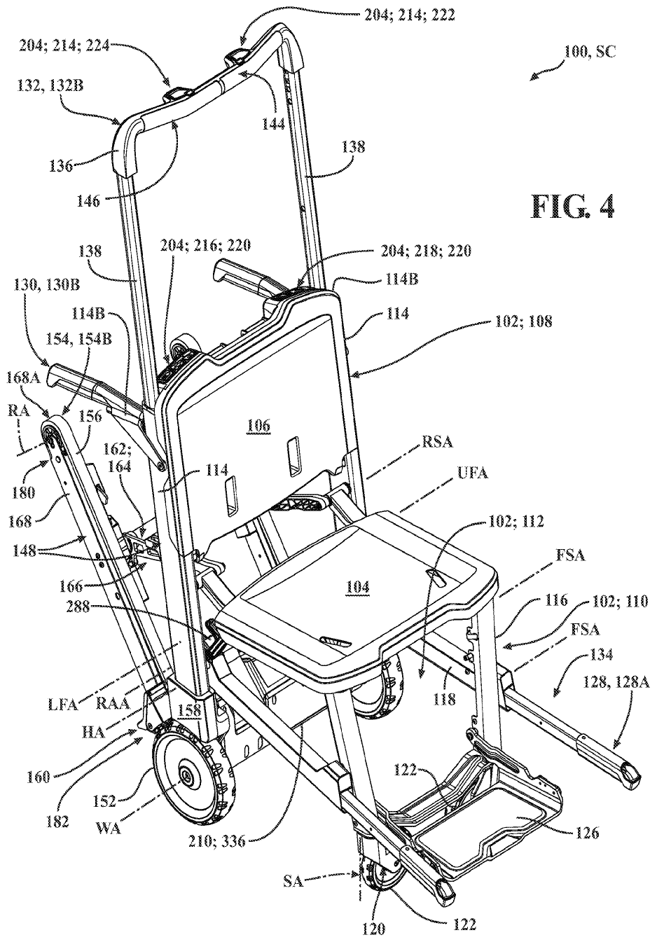

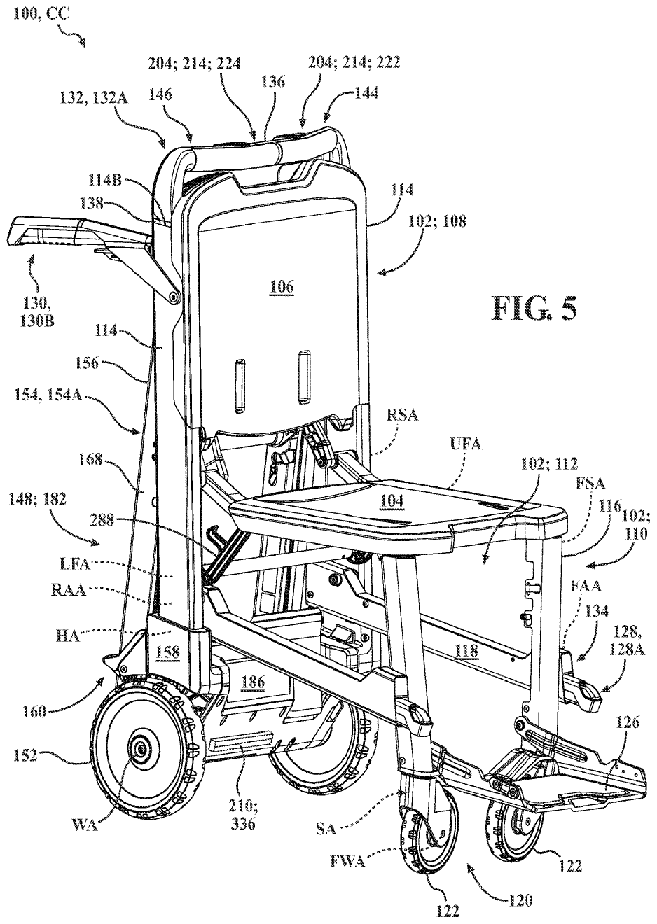

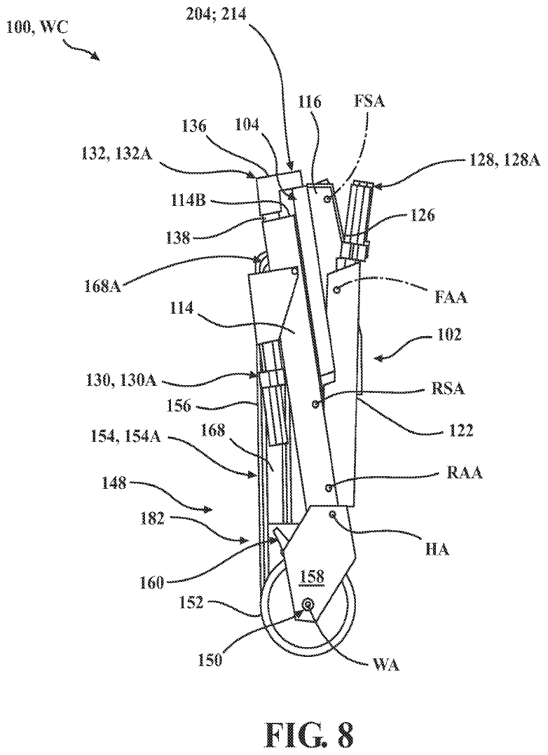

The patient transport apparatus 100 is realized as a “stair chair”, which can be operated in a chair configuration CC (see FIG. 5) to transport the patient across ground or floor surfaces FS (e.g., pavement, hallways, and the like), a stair configuration SC (see FIG. 4) to transport the patient along stairs ST, and a stowed (or folded) configuration FC (see FIG. 8) when not being utilized to transport patients. As will be appreciated from the subsequent description below, the patient transport apparatus 100 may be stored or otherwise transported in the transport vehicle 50 in the stowed configuration FC.

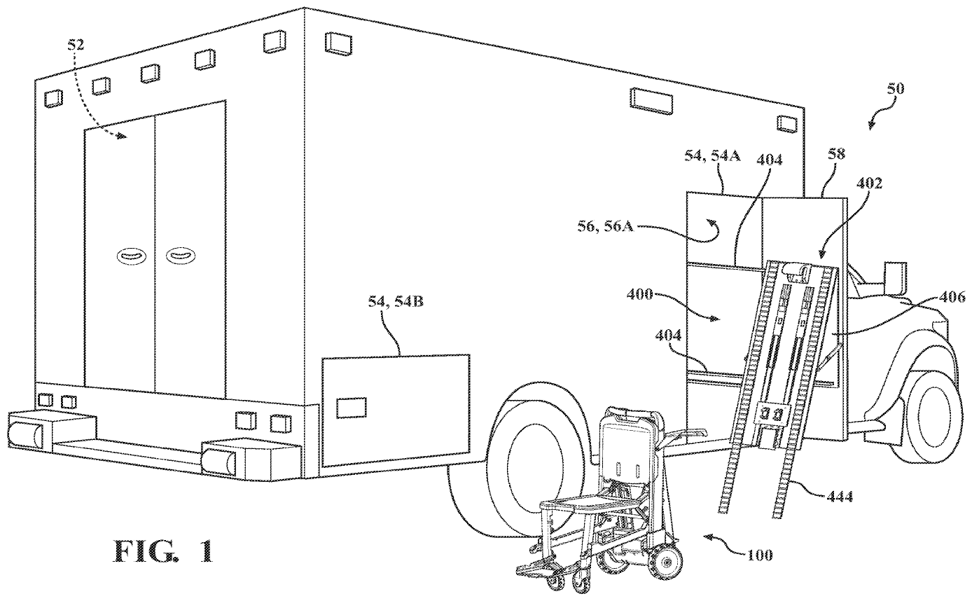

In FIG. 1, a first exemplary transport vehicle 50 is shown as an ambulance. The transport vehicle generally comprises an interior volume 52 in which a patient and caregivers are located during use. The interior volume 52 may include a system for loading an ambulance cot (not shown) to aid caregivers in loading the patient and cot into the transport vehicle 50. In addition to the interior volume 52, the transport vehicle 50 may further comprise one or more storage compartments 54 that define a corresponding cargo volume 56, which is accessible from an exterior of the transport vehicle 50 through a corresponding door 58. The storage compartments 54 facilitate quick and easy access to equipment that a caregiver may need to aid a patient. The cargo volume 56 of the storage compartment 54 may further be accessible from the interior volume 52 of the transport vehicle 50 in order to access the contents of the cargo volume 56 while the transport vehicle 50 is moving.

In addition to the aforementioned cot, caregivers may also utilize other patient transport apparatuses 100, such as the patient transport apparatus 100 illustrated throughout the drawings, which facilitates transporting a patient up and down a flight of stairs ST. Generally, once the patient has reached the “ground floor” (i.e., the same as the transport vehicle) of a particular location and is otherwise accessible by a wheeled ambulance cot, the patient is transferred from the patient transport apparatus 100 to wheeled ambulance cot and loaded into the interior volume 52 of the transport vehicle 50. As such, the patient is generally not transported within the transport vehicle 50 while seated in the patient transport apparatus 100. Said differently, unlike an ambulance cot, the patient transport apparatus 100 is intended to be unoccupied when transported by the transport vehicle 50, and caregiver access to the patient transport apparatus 100 while the transport vehicle 50 is in motion is unnecessary. It is therefore beneficial to minimize the storage volume required to transport the patient transport apparatus 100 within the transport vehicle 50, which may likewise increase the difficulty of loading the patient transport apparatus 100 into the transport vehicle 50, particularly when the patient transport apparatus 100 is heavy or unwieldy.

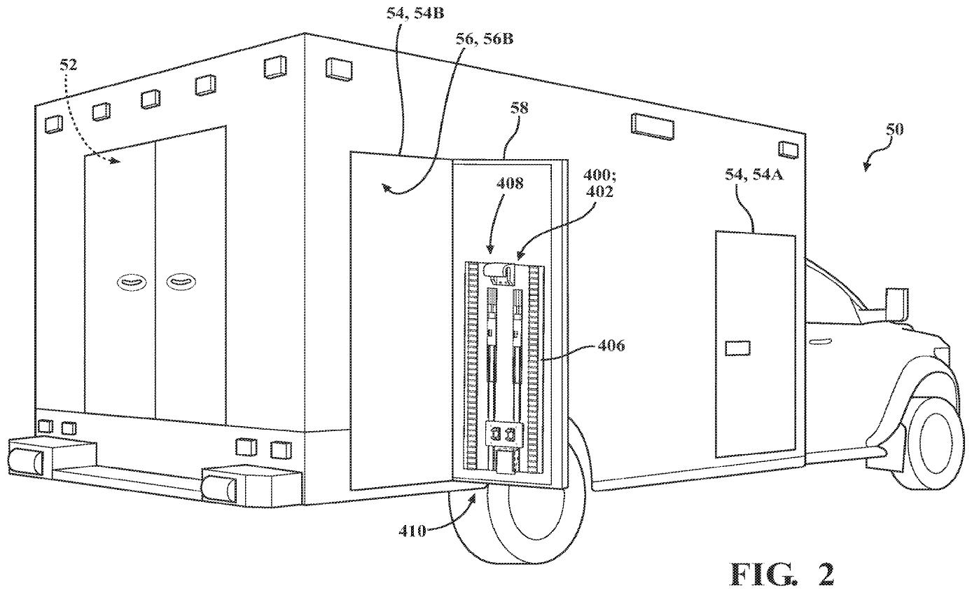

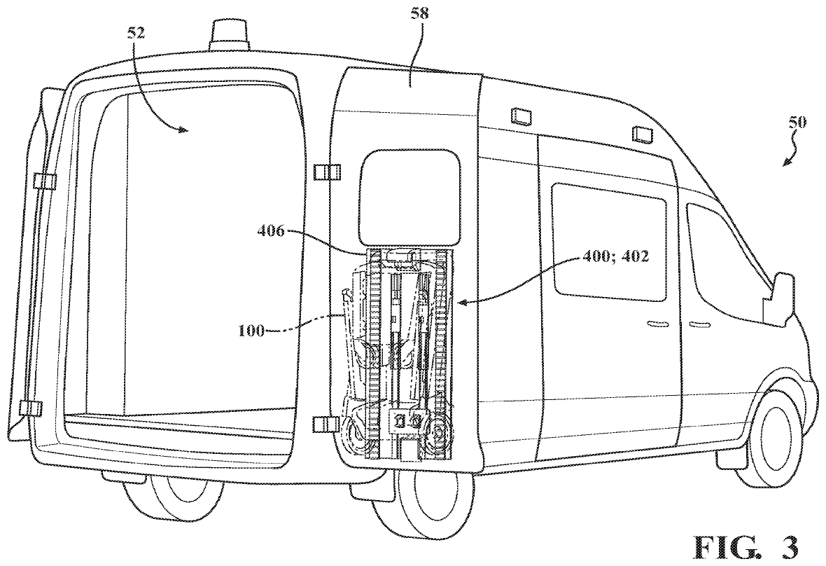

To this end, the transport vehicle 50 and the loading system 400 may be used in combination to facilitate loading the patient transport apparatus 100. Because the patient transport apparatus 100 is not needed while the transport vehicle 50 is in motion, the patient transport apparatus 100 may advantageously be stored in one of the storage compartments 54 on the exterior of the transport vehicle 50. The loading system 400 may aid lifting the patient transport apparatus 100 into the associate cargo volume 56. FIG. 1 illustrates a first such arrangement whereby the transport vehicle 50 has a first storage compartment 54A with the loading system 400 configured to lift the patient transport apparatus 100 for placement into the first cargo volume 56A. FIGS. 2 and 3 illustrate another arrangement of the transport vehicle having a second storage compartment 54B with the loading system 400 configured to lift the patient transport apparatus 100 for placement into the second cargo volume 56B.

As is best shown in FIG. 5, the patient transport apparatus 100 comprises a support structure 102 to which a seat section 104 and a back section 106 are operatively attached. The seat section 104 and the back section 106 are each shaped and arranged to provide support to the patient during transport. The support structure 102 generally includes a rear support assembly 108, a front support assembly 110, and an intermediate support assembly 112. The back section 106 is coupled to the rear support assembly 108 for concurrent movement. To this end, the rear support assembly 108 comprises a first rear upright 114A arranged on a first side of the rear support assembly 108. The rear support assembly 108 may further comprise a second read upright 114B on a second side of the rear support assembly 108, opposite the first side. The rear uprights 114A, 114B may extend generally vertically and are secured to the back section 106 such as with fasteners (not shown in detail).

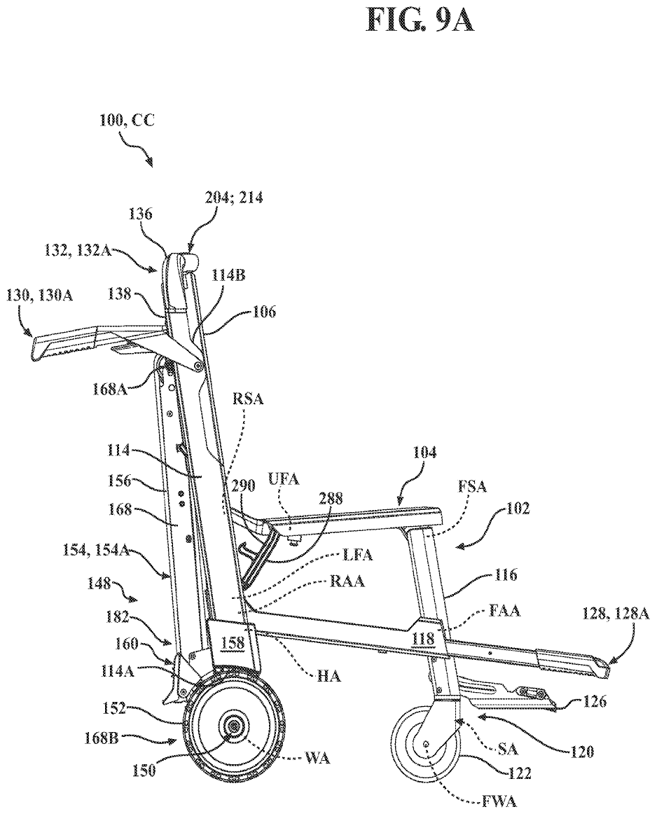

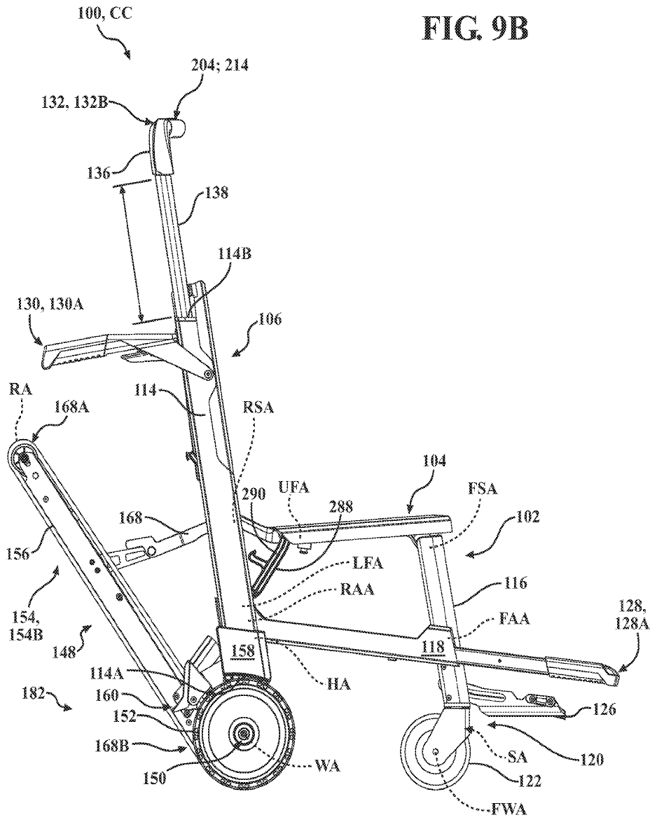

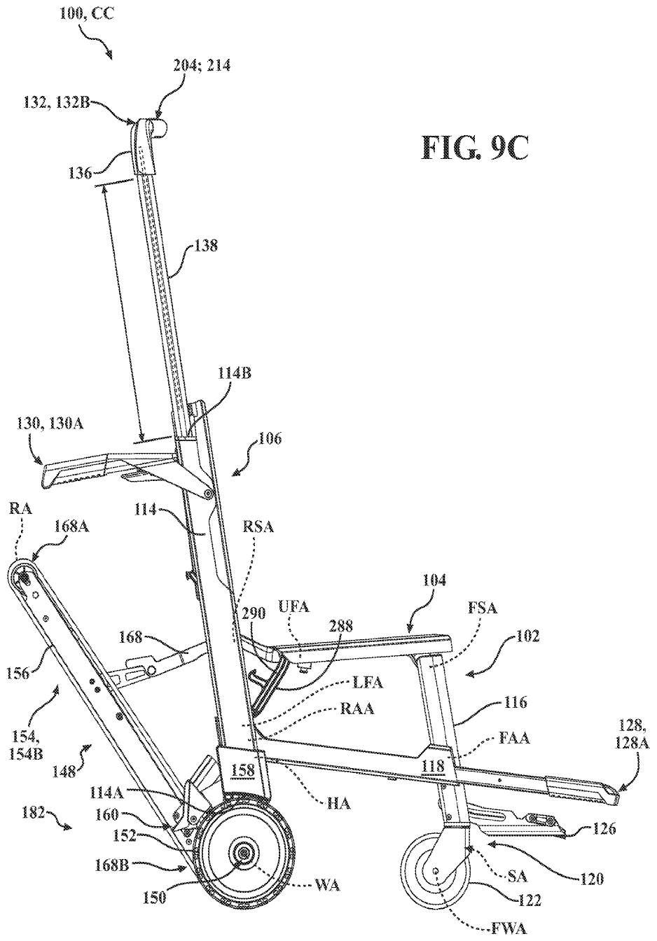

The intermediate support assembly 112 and the seat section 104 are each pivotably coupled to the rear support assembly 108. More specifically, the seat section 104 is arranged so as to pivot about a rear seat axis RSA which extends through the rear uprights 114A, 114B (compare FIGS. 8-9A; pivoting about rear seat axis RSA not shown in detail), and the intermediate arms 118 of the intermediate support assembly 112 are arranged so as to pivot about a rear arm axis RAA which is spaced from the rear seat axis RSA and also extends through the rear uprights 114A, 114B (compare FIGS. 8-9A; pivoting about rear arm axis RAA not shown in detail). Furthermore, the intermediate support assembly 112 and the seat section 104 are also each pivotably coupled to the front support assembly 110. Here, the seat section 104 pivots about a front seat axis FSA which extends through the front struts 116 (compare FIGS. 8-9A; pivoting about front seat axis FSA not shown in detail), and the intermediate arms 118 pivot about a front arm axis FAA which is spaced from the front seat axis FSA and extends through the front struts 116 (compare FIGS. 8-9A; pivoting about front arm axis FAA not shown in detail). The intermediate support assembly 112 is disposed generally vertically below the seat section 104 such that the rear support assembly 108, the front support assembly 110, the intermediate support assembly 112, and the seat section 104 generally define a four-bar linkage which helps facilitate movement between the stowed configuration FC (see FIG. 8) and the chair configuration CC (see FIG. 9A). While the seat section 104 is generally configured to remain stationary relative to the support structure 102 when operating in the chair configuration CC or in the stair configuration CC according to the illustrated versions, it is contemplated that the seat section 104 could comprise multiple components which cooperate to facilitate “sliding” movement relative to the seat section 104 under certain operating conditions, such as to position the patient's center of gravity advantageously for transport. Other configurations are contemplated.

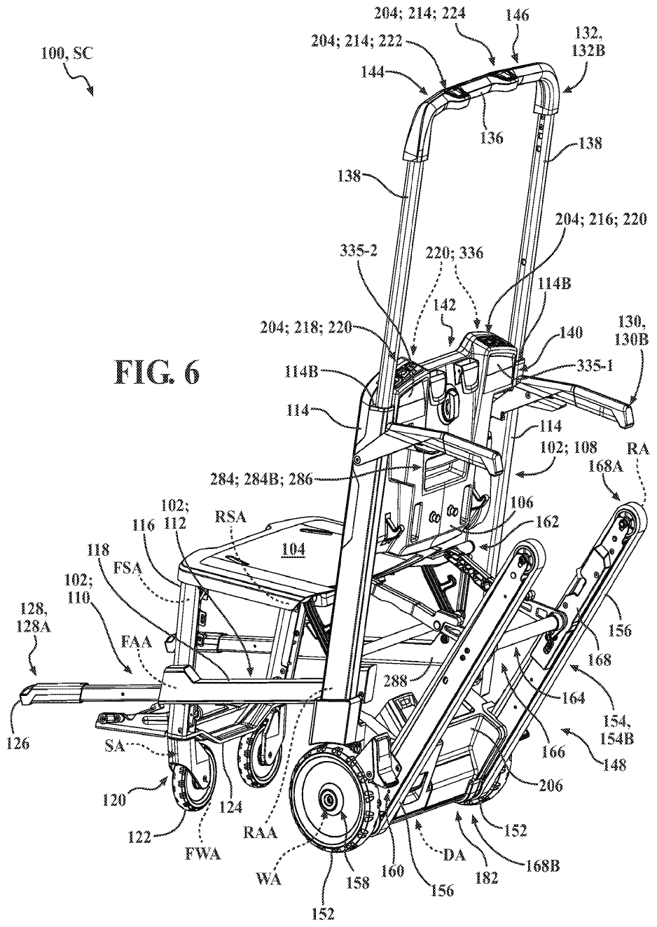

Referring now to FIGS. 4-6, the front support assembly 110 includes a pair of caster assemblies 120 which each comprise a front wheel 122 arranged to rotate about a respective front wheel axis FWA and to pivot about a respective swivel axis SA (compare FIGS. 8-9A; pivoting about swivel axis SA not shown in detail). The caster assemblies 120 are generally arranged on opposing lateral sides of the front support assembly 110 and are operatively attached to the front struts 116. A lateral brace 124 (see FIG. 6) extends laterally between the front struts 116 to, among other things, afford rigidity to the support structure 102. Here, a foot rest 126 is pivotably coupled to each of the front struts 116 adjacent to the caster assemblies 120 (pivoting not shown in detail) to provide support to the patient's feet during transport. For each of the pivotable connections disclosed herein, it will be appreciated that one or more fasteners, bushings, bearings, washers, spacers, and the like may be provided to facilitate smooth pivoting motion between various components.

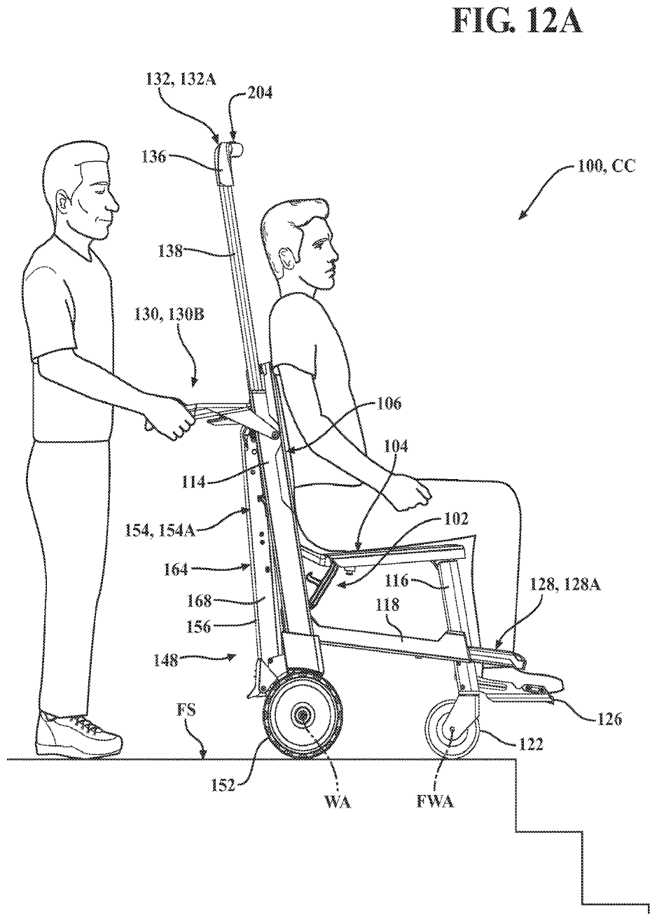

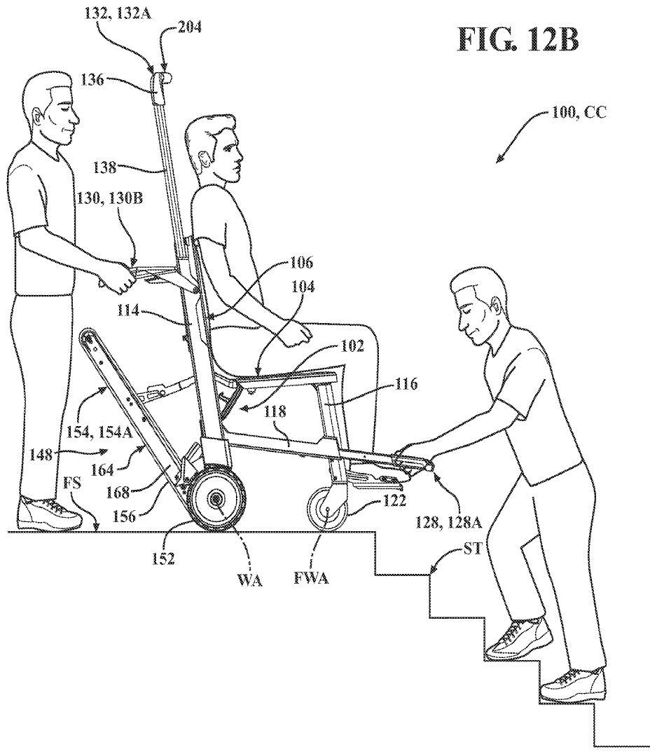

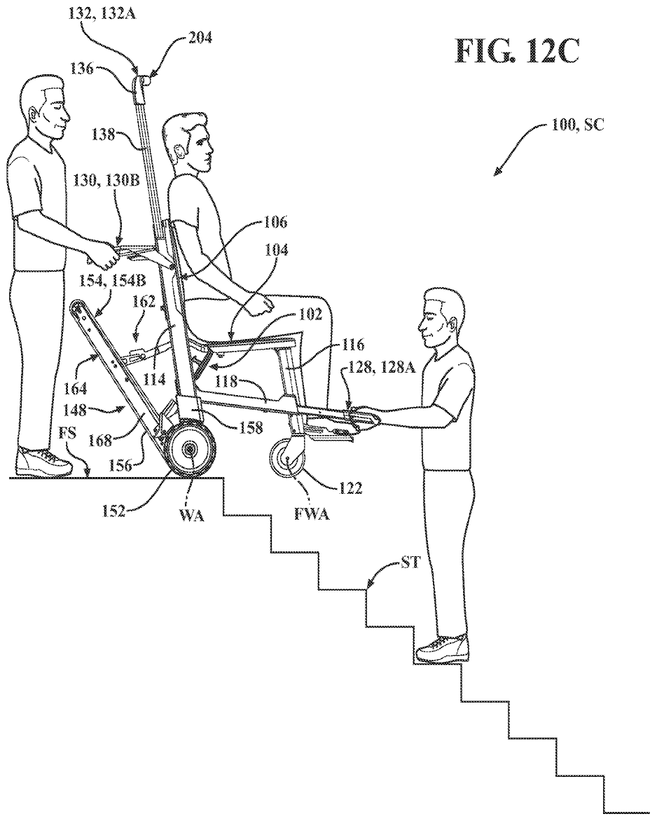

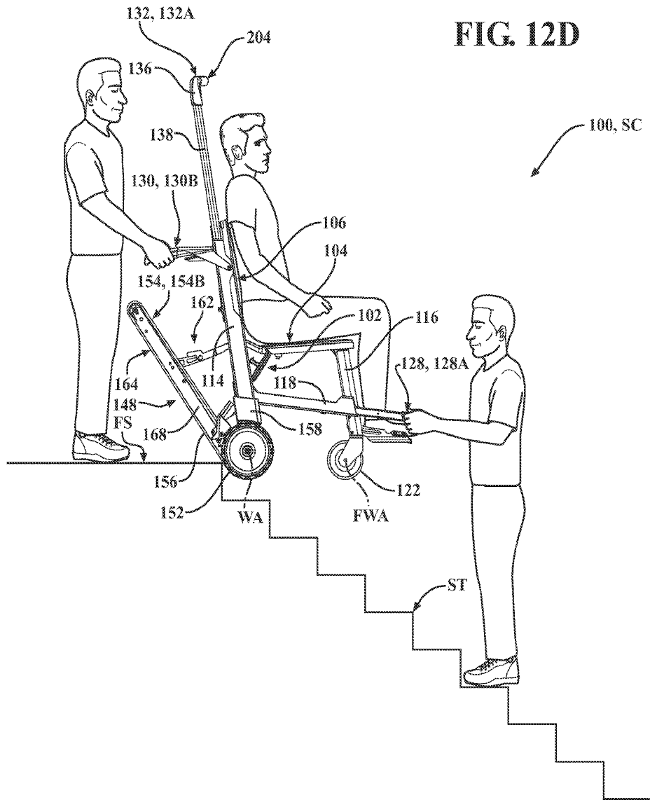

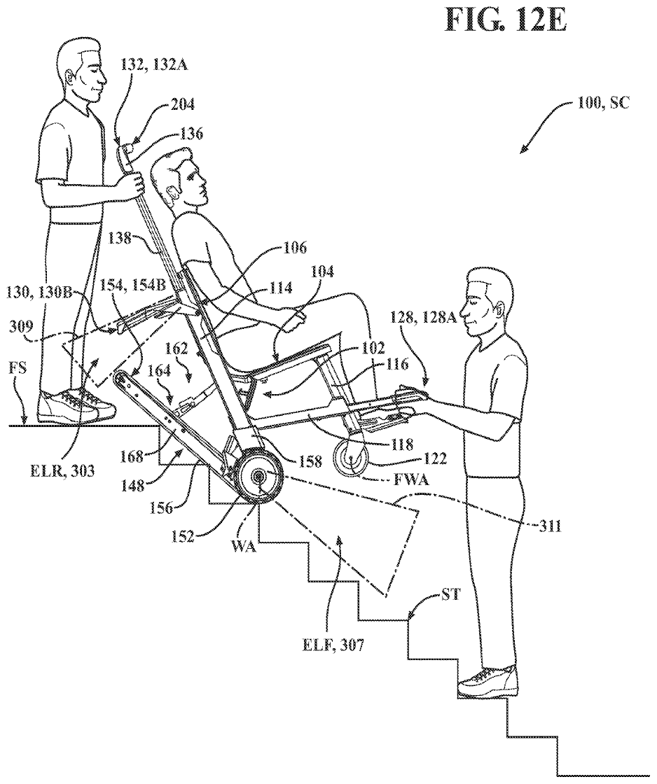

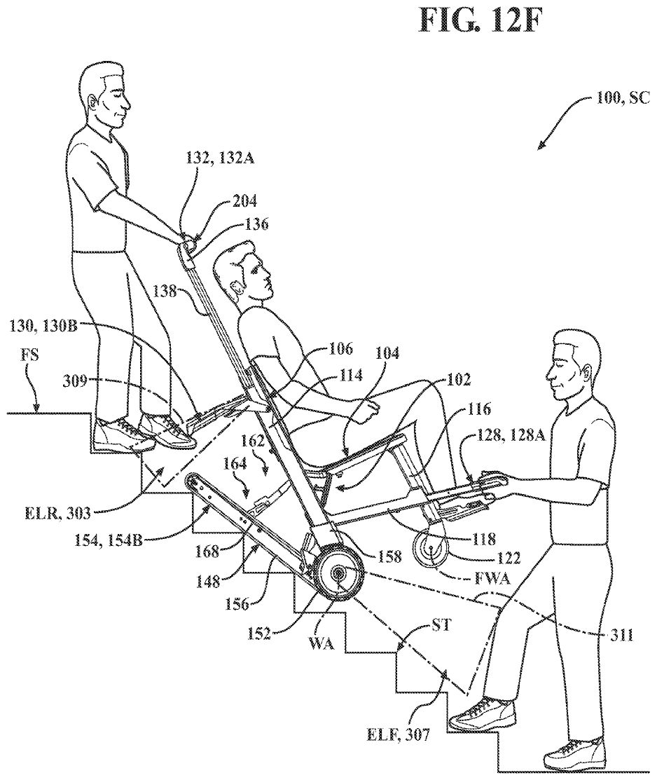

The representative versions of the patient transport apparatus 100 illustrated throughout the drawings comprise different handles arranged for engagement by caregivers during patient transport. More specifically, the patient transport apparatus 100 comprises front handle assemblies 128, pivoting handle assemblies 130, and an upper handle assembly 132 (hereinafter referred to as “handle assembly 132”), each of which will be described in greater detail below. The front handle assemblies 128 are supported within the respective intermediate arms 118 for movement between a collapsed position 128A (see FIG. 12A) and an extended position 128B (see FIG. 12B). To this end, the front handle assemblies 128 may be slidably supported by bushings, bearings, and the like (not shown) coupled to the intermediate arms 118, and may be lockable in and/or between the collapsed position 128A and the extended position 128B via respective front handle locks 134 (see FIG. 5).

Here, a caregiver may engage the front handle locks 134 (not shown in detail) to facilitate moving the front handle assemblies 128 between the collapsed position 128A and the extended position 128B. The front handle assemblies 128 are generally arranged so as to be engaged by a caregiver during patient transport up or down stairs ST when in the extended position 128B. It will be appreciated that the front handle assemblies 128 could be of various types, styles, and/or configurations suitable to be engaged by caregivers to support the patient transport apparatus 100 for movement. While the illustrated front handle assemblies 128 are arranged for telescoping movement, other configurations are contemplated. By way of non-limiting example, the front handle assemblies 128 could be pivotably coupled to the support structure 102 or other parts of the patient transport apparatus 100. In some versions, the front handle assemblies 128 could be configured similar to as is disclosed in U.S. Pat. No. 6,648,343, the disclosure of which is hereby incorporated by reference in its entirety.

The pivoting handle assemblies 130 are coupled to the respective rear uprights 114A, 114B of the rear support assembly 108, and are movable relative to the rear uprights 114A, 114B between a stowed position 130A and an engagement position 130B. Like the front handle assemblies 128, the pivoting handle assemblies 130 are generally arranged for engagement by a caregiver during patient transport, and may advantageously be utilized in the engagement position 130B when the patient transport apparatus 100 operates in the chair configuration CC to transport the patient along floor surfaces FS. In some versions, the pivoting handle assemblies 130 could be configured similar to as is disclosed in U.S. Pat. No. 6,648,343, previously incorporated by reference. Other configurations are contemplated.

As is best depicted in FIG. 9A, the rear uprights 114A, 114B each generally extend between a lower upright end 115A and an upper upright end 115B, with the hub axis HA arranged adjacent to the lower upright end 115A. The lower upright end 115A is supported for movement within the hub 158, which may comprise a hollow profile or recess defined by multiple hub housing components. In the illustrated version, the hub axis HA is arranged generally vertically between the rear arm axis RAA and the wheel axis WA. The rear uprights 114A, 114B may each comprise a generally hollow, extruded profile which supports various components of the patient transport apparatus 100.

As best shown in FIG. 5, the handle assembly 132 includes an upper grip 136. The upper grip 136 is operatively attached to a first extension post 138A. The first extension post 138A is disposed within the first rear upright 114A. Accordingly, the first extension post 138A supports the upper grip 136 for movement of the handle assembly 132 between a collapsed position 132A where the upper grip is disposed adjacent to the user interface (see FIG. 5 and an extended position 132B where the upper grip is spaced from the user interface (see FIG. 4). In some examples, the upper grip 136 may extend between a first upper grip end 136A and a second upper grip end 136B. The first extension post 138A may be operatively attached to the first upper grip end 136A. The handle assembly 132 may further include a second extension post 138B operatively attached to the second upper grip end 136B. Together, the first and second extension posts 138A, 138B may support the upper grip 136 for movement of the handle assembly 132 between the collapsed position 132A and the extended position 132B.

In the representative version illustrated herein, the upper grip 136 generally comprises a first hand grip region 144 arranged adjacent to the first extension posts 138A, and a second hand grip region 146 arranged adjacent to the second extension post 138B, each of which may be engaged by the caregiver to support the patient transport apparatus 100 for movement, such as during patient transport up or down stairs ST (see FIGS. 12A-12F). The activation input controls 214 may be arranged in various locations about the patient transport apparatus 100. In the illustrated versions, a first activation input control 222 is disposed adjacent to the first hand grip region 144 of the handle assembly 132, and a second activation input control 224 is disposed adjacent to the second hand grip region 146 (best shown in FIG. 5). In the illustrated version, the user interface 204 is configured such that the caregiver can engage either of the activation input controls 222, 224 with a single hand grasping the upper grip 136 (described below) of the handle assembly 132 during use.

The activation input controls 214 may be arranged between the first and second hand grip regions 144, 146 in order to facilitate user engagement of the activation input controls 214 from either of the first and second hand grip regions 144, 146. As previously discussed, the activation input controls 214 include the first activation input control 222 and the second activation input control 224. The first activation input control 222 may be disposed adjacent the first hand grip region 144 so as to facilitate user engagement of the first activation input control 222 from the first hand grip region 144. The second activation input control 224 may be disposed adjacent to the second hand grip region 146 so as to facilitate user engagement of the second activation input control 224 from the second hand grip region 146. Here, it will be appreciated that the user can engage either of the first and second hang grip regions 144, 146 with one of their hands to support the patient transport apparatus 100 while, at the same, using that same hand to activate one of the first and second activation input controls 222, 224 (e.g., reaching with their thumb).

The first activation input control 222 and the second activation input control 224 may be spaced apart by a predetermined distance (e.g., several inches) and are wired in parallel in some versions (not shown in detail).

Referring to FIGS. 9A-9C, the handle assembly 132 is configured for movement between the extended position 132B (shown in FIG. 9A) where the upper grip 136 is spaced from the user interface 204 at a first distance D1, and the collapsed position 132A (shown in FIG. 9C) where the upper grip 136 is disposed adjacent to the user interface 204. Additionally, the handle assembly 132 may be configured for movement to an intermediate position 132C (shown in FIG. 9B) where the upper grip 136 is spaced from the user interface 204 at a second distance D2, less than the first distance D1.

As noted above, the patient transport apparatus 100 is configured for use in transporting the patient across floor surfaces FS, such as when operating in the stair configuration SC, and for transporting the patient along stairs ST when operating in the stair configuration SC. To these ends, the illustrated patient transport apparatus 100 includes a carrier assembly 148 arranged for movement relative to the support structure 102 between the chair configuration CC and the stair configuration ST. The carrier assembly 148 generally comprises at least one shaft 150 defining a wheel axis WA, one or more rear wheels 152 supported for rotation about the wheel axis WA, at least one track assembly 154 having a belt 156 for engaging stairs ST, and one or more hubs 158 supporting the shaft 150 and the track assembly 154 and the shaft 150 for concurrent pivoting movement about a hub axis HA. Here, movement of the carrier assembly 148 from the chair configuration CC (see FIG. 5) to the stair configuration SC (see FIGS. 4 and 9B) simultaneously deploys the track assembly 154 for engaging stairs ST with the belt 156 and moves the wheel axis WA longitudinally closer to the front support assembly 110 so as to position the rear wheels 152 further underneath the seat section 104 and closer to the front wheels 122.

As is described in greater detail below in connection with FIGS. 12A-12F, the movement of the rear wheels 152 relative to the front wheels 122 when transitioning from the chair configuration CC to the stair configuration SC that is afforded by the patient transport apparatus 100 of the present disclosure affords significant improvements in patient comfort and caregiver usability, in that the rear wheels 152 are arranged to promote stable transport across floor surfaces FS in the chair configuration CC but are arranged to promote easy transitioning from floor surfaces to stairs ST as the patient transport apparatus 100 is “tilted” backwards about the rear wheels 152 (compare FIGS. 12D-12F). Put differently, positioning the rear wheels 152 relative to the front wheels 122 consistent with the present disclosure makes “tilting” the patient transport apparatus 100 significantly less burdensome for the caregivers and, at the same time, much more comfortable for the patient due to the arrangement of the patient's center of gravity relative to the portion of the rear wheels 152 contacting the floor surface FS as the patient transport apparatus 100 is “tilted” backwards to transition into engagement with the stairs ST.

In the representative versions illustrated herein, the carrier assembly 148 comprises hubs 158 that are pivotably coupled to the respective rear uprights 114A, 114B for concurrent movement about the hub axis HA. Here, one or more bearings, bushings, shafts, fasteners, and the like (not shown in detail) may be provided to facilitate pivoting motion of the hubs 158 relative to the rear uprights 114A, 114B. Similarly, bearings and/or bushings (not shown) may be provided to facilitate smooth rotation of the rear wheels 152 about the wheel axis WA. Here, the shafts 150 may be fixed to the hubs 158 such that the rear wheels 152 rotate about the shafts 150 (e.g., about bearings supported in the rear wheels 152), or the shafts 150 could be supported for rotation relative to the hubs 158. Each of the rear wheels 152 is also provided with a wheel lock 160 coupled to its respective hub 158 to facilitate inhibiting rotation about the wheel axis WA. The wheel locks 160 are generally pivotable relative to the hubs 158, and may be configured in a number of different ways without departing from the scope of the present disclosure. While the representative version of the patient transport apparatus 100 illustrated herein employs hubs 158 with “mirrored” profiles that are coupled to the respective rear uprights 114A, 114B and support discrete shafts 150 and wheel locks 160, it will be appreciated that a single hub 158 and/or a single shaft 150 could be employed. Other configurations are contemplated.

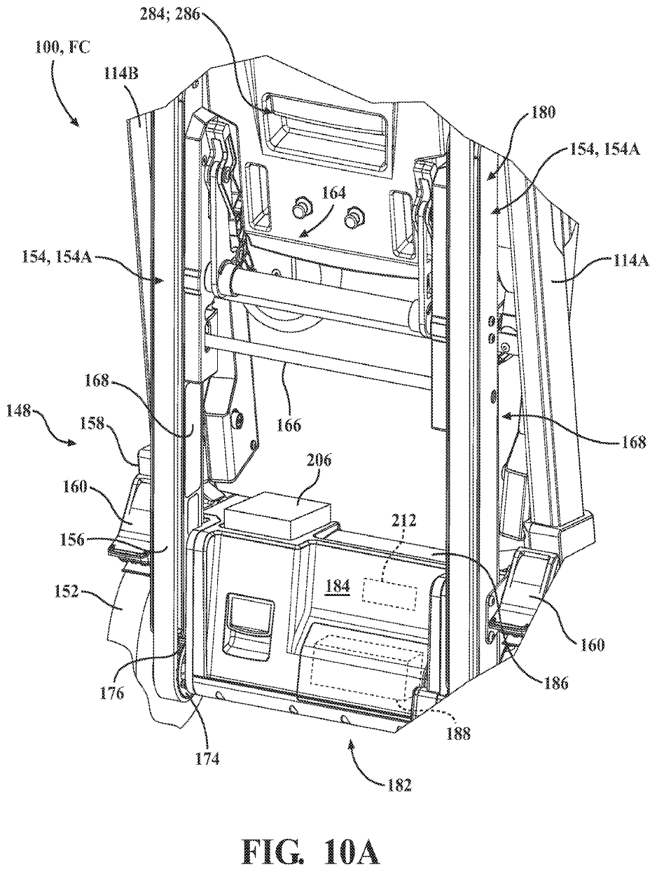

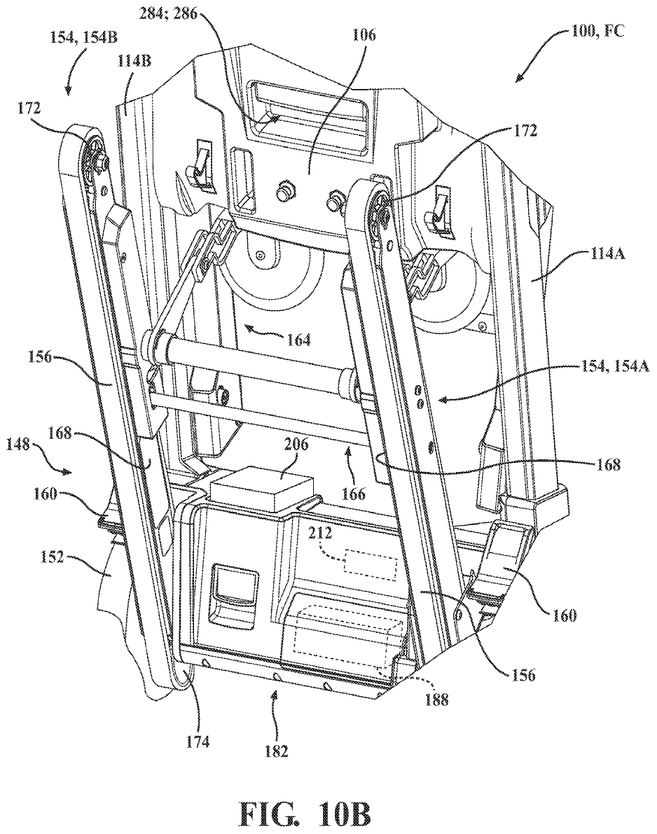

Referring now to FIGS. 10A-10B, as noted above, the track assemblies 154 move concurrently with the hubs 158 between the chair configuration CC and the stair configuration SC. Here, the track assemblies 154 are arranged in a retracted position 154A when the carrier assembly 148 is disposed in the chair configuration CC, and are disposed in a deployed position 154B when the carrier assembly 148 is disposed in the stair configuration SC. As is described in greater detail below, the illustrated patient transport apparatus 100 comprises a deployment linkage 162 and a deployment lock mechanism 164 with a deployment lock release 166 arranged for engagement by the caregiver to facilitate changing between the retracted position 154A and the deployed position 154B (and, thus, between the chair configuration CC and the stair configuration SC).

In the illustrated version, the patient transport apparatus 100 comprises laterally-spaced track assemblies 154 each having a single belt 156 arranged to contact stairs ST. However, it will be appreciated that other configurations are contemplated, and a single track assembly 154 and/or track assemblies with multiple belts 156 could be employed. The track assemblies 154 each generally comprise a rail 168 extending between a first rail end 168A and a second rail end 168B. The second rail end 168B is operatively attached to the hub 158, such as with one or more fasteners (not shown in detail). An axle 170 defining a roller axis RA is disposed adjacent to the first rail end 168A of each rail 168, and a roller 172 is supported for rotation about the roller axis RA. For each of the track assemblies 154, the belt 156 is disposed in engagement with the roller 172 and is arranged for movement relative to the rail 168 in response to rotation of the roller 172 about the roller axis RA.

The track assemblies 154 may further comprise a cross brace 173 extending laterally therebetween. The cross brace 173 is coupled to the rail 168 of each track assembly 154 to effect coordinated motion of the track assemblies 154. Said differently, movement of one of the track assemblies 154 between the retracted position 154A and the deployed position 154B causes corresponding movement of the other track assembly 154. The cross brace 173 may further provide increased resistance to deflection of the track assemblies 154 when subjected to lateral loads near the first rail end 168A by transferring force exerted on one track assembly 154 to the other track assembly 154. The cross brace 173 may be coupled to the rails 168 with threaded fasteners or may be permanently coupled to the rails 168 by way of a welding process.

Adjacent to the second rail end 168B of each rail 168, a drive pulley 174 is supported for rotation about a drive axis DA and is likewise disposed in engagement with the belt 156 (see FIGS. 10A-10B; rotation about drive axis DA not shown in detail). Here, the drive pulley 174 comprises outer teeth 176 which are disposed in engagement with inner teeth 178 formed on the belt 156. The track assemblies 154 each also comprise a belt tensioner, generally indicated at 180, configured to adjust tension in the belt 156 between the roller 172 and the drive pulley 174.

In the representative version illustrated herein, the patient transport apparatus 100 comprises a drive system, generally indicated at 182, configured to facilitate driving the belts 156 of the track assemblies 154 relative to the rails 168 to facilitate movement of the patient transport apparatus 100 up and down stairs ST. To this end, and as is depicted in FIG. 10A, the drive system 182 comprises a drive frame 184 and a cover 186 which are operatively attached to the hubs 158 of the carrier assembly 148 for concurrent movement with the track assemblies 154 between the retracted position 154A and the deployed position 154B. A motor 188 (depicted in phantom in FIG. 10A) is coupled to the drive frame 184 and is concealed by the cover 186. The motor 188 is configured to selectively generate rotational torque used to drive the belts 156 via the drive pulleys 174, as described in greater detail below. To this end, a drive axle 190 is coupled to each of the drive pulleys 174 and extends along the drive axis DA laterally between the track assemblies 154. The drive axle 190 is rotatably supported by the drive frame 184, such as by one or more bearings, bushings, and the like (not shown in detail). A geartrain 192 is disposed in rotational communication between the motor 188 and the drive axle 190. To this end, in the version depicted in FIG. 10A, the geartrain 192 comprises a first sprocket 194, a second sprocket 196, and an endless chain 198. Here, the motor 188 comprises an output shaft 200 to which the first sprocket 194 is coupled, and the second sprocket 196 is coupled to the drive axle 190. The endless chain 198, in turn, is supported about the first sprocket 194 and the second sprocket 196 such that the drive axle 190 and the output shaft 200 rotate concurrently. The geartrain 192 may be configured so as to adjust the rotational speed and/or torque of the drive axle 190 relative to the output shaft 200 of the motor, such as by employing differently-configured first and second sprockets 194, 196 (e.g., different diameters, different numbers of teeth, and the like).

While the representative version of the drive system 182 illustrated herein utilizes a single motor 188 to drive the belts 156 of the track assemblies 154 concurrently using a chain-based geartrain 192, it will be appreciated that other configurations are contemplated. By way of non-limiting example, multiple motors 188 could be employed, such as to facilitate driving the belts 156 of the track assemblies 154 independently. Furthermore, different types of geartrains 192 are contemplated by the present disclosure, including without limitation the geartrains 192 which comprise various arrangements of gears, planetary gearsets, and the like.

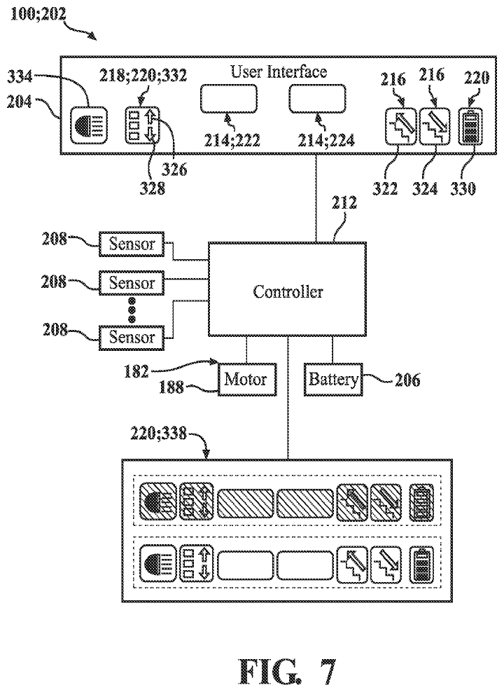

The patient transport apparatus 100 comprises a control system 202 to, among other things, facilitate control of the track assemblies 154. To this end, and as is depicted schematically in FIG. 7, the representative version of the control system 202 generally comprises a user interface 204, a battery 206, one or more sensors 208, and one or more back light modules 210 which are disposed in electrical communication with a controller 212. As will be appreciated from the subsequent description below, the controller 212 may be of a number of different types, styles, and/or configurations, and may employ one or more microprocessors for processing instructions or an algorithm stored in memory to control operation of the motor 188, the light modules 210, and the like. Additionally or alternatively, the controller 212 may comprise one or more sub-controllers, microcontrollers, field programmable gate arrays, systems on a chip, discrete circuitry, and/or other suitable hardware, software, and/or firmware that is capable of carrying out the functions described herein.

The controller 212 is coupled to various electrical components of the patient transport apparatus 100 (e.g., the motor 188) in a manner that allows the controller 212 to control or otherwise interact with those electrical components the (e.g., via wired and/or wireless electrical communication). In some versions, the controller 212 may generate and transmit control signals to the one or more powered devices, or components thereof, to drive or otherwise facilitate operating those powered devices, or to cause the one or more powered devices to perform one or more of their respective functions.

The controller 212 may utilize various types of sensors 208 of the control system 202, including without limitation force sensors (e.g., load cells), timers, switches, optical sensors, electromagnetic sensors, motion sensors, accelerometers, potentiometers, infrared sensors, ultrasonic sensors, mechanical limit switches, membrane switches, encoders, and/or cameras. One or more sensors 208 may be used to detect mechanical, electrical, and/or electromagnetic coupling between components of the patient transport apparatus 100. Other types of sensors 208 are also contemplated. Some of the sensors 208 may monitor thresholds movement relative to discrete reference points. The sensors 208 can be located anywhere on the patient transport apparatus 100, or remote from the patient transport apparatus 100. Other configurations are contemplated.

The battery 206 provides power to the controller 212, the motor 188, the light modules 210, and other components of the patient transport apparatus 100 during use, and is removably attachable to the cover 186 of the drive system 182 in the illustrated version (see FIG. 10A; attachment not shown in detail). The user interface 204 is generally configured to facilitate controlling the drive direction and drive speed of the motor 188 to move the belts 156 of the track assembly 154 and, thus, allow the patient transport apparatus 100 to ascend or descend stairs ST. Here, the user interface 204 may comprise one or more activation input controls 214 to facilitate driving the motor 188 in response to engagement by the caregiver, one or more direction input controls 216 to facilitate changing the drive direction of the motor 188 in response to engagement by the caregiver, and/or one or more speed input controls 218 to facilitate operating the motor 188 at different predetermined speeds selectable by the caregiver. The one or more direction input controls 216 and the one or more speed input controls 218 may be coupled to the rear support assembly 108 and referred to as lower input controls 219. The user interface 204 may also comprise various types of indicators 220 to display information to the caregiver. It will be appreciated that the various components of the control system 202 introduced above could be configured and/or arranged in a number of different ways, and could communicate with each other via one or more types of electrical communication facilitated by wired and/or wireless connections. Other configurations are contemplated.

In the illustrated versions, the patient transport apparatus 100 is configured to limit movement of the belts 156 relative to the rails 168 during transport along stairs ST in an absence of engagement with the activation input controls 214 by the caregiver. Put differently, one or more of the controller 212, the motor 188, the geartrain 192, and/or the track assemblies 154 may be configured to “brake” or otherwise prevent movement of the belts 156 unless the activation input controls 214 are engaged. To this end, the motor 188 may be controlled via the controller 212 to prevent rotation (e.g., driving with a 0% pulse-width modulation PWM signal) in some versions. However, other configurations are contemplated, and the patient transport apparatus 100 could be configured to prevent movement of the belts 156 in other ways. By way of non-limiting example, a mechanical brake system (not shown) could be employed in some versions.

Referring now to FIG. 10A, the patient transport apparatus 100 employs the deployment lock mechanism 164 to releasably secure the track assembly 154 in the retracted position 154A and in the deployed position 154B. The deployment lock release 166 is arranged for engagement by the caregiver to move between the retracted position 154A and the deployed position 154B. The deployment lock mechanism 164 is coupled to the track assemblies 154 for concurrent movement, and the deployment linkage 162 is coupled between the deployment lock mechanism 164 and the support structure 102. The illustrated deployment linkage 162 generally comprises connecting links 226 which are pivotably coupled to the support structure 102, and brace links 228 which are coupled to the deployment lock mechanism 164 and are respectively pivotably coupled to the connecting links 226.

The connecting links 226 each comprise or otherwise define a forward pivot region 230, a connecting pivot region 232, a trunnion region 234, and an interface region 236. The forward pivot regions 230 extend from the interface regions 236 to forward pivot mounts 238 which are pivotably coupled to the rear uprights 114A, 114B about the rear seat axis RSA, such as by one or more fasteners, bushings, bearings, and the like (not shown in detail). Here, because the rear uprights 114A, 114B are spaced laterally away from each other at a distance large enough to allow the track assemblies 154 to “nest” therebetween in the retracted position 154A (see FIG. 10A), the forward pivot regions 230 of the connecting links 226 extend at an angle away from the rear uprights 114A, 114B at least partially laterally towards the track assemblies 154.

The trunnion regions 234 extend generally vertically downwardly from the interface regions 236 to trunnion mount ends 240, and comprise trunnions 242 which extend generally laterally and are arranged to abut trunnion catches 244 of the deployment lock mechanism 164 to retain the track assemblies 154 in the retracted position 154A (see FIG. 10A). The connecting pivot regions 232 extend longitudinally away from the interface regions 236 to rearward pivot mounts 246 which pivotably couple to the brace links 228 about a link axis LA. The connecting links 226 are each formed as separate components with mirrored profiles in the illustrated versions, but could be realized in other ways, with any suitable number of components.

The brace links 228 each generally extend between an abutment link end 250 and a rearward link mount 252, with a forward link mount 254 arranged therebetween. The forward link mounts 254 are pivotably coupled to the rearward pivot mounts 246 of the connecting links 226 about the link axis LA, such as by one or more fasteners, bushings, bearings, and the like (not shown in detail). The rearward link mounts 252 are each operatively attached to the deployment lock mechanism 164 about a barrel axis BA. The brace links 228 each define a link abutment surface 256 disposed adjacent to the abutment link end 250 which are arranged to abut the link stops 248 of the connecting links 226 in the deployed position 154B (see FIG. 10B). The brace links 228 also define a relief region 258 formed between the forward link mount 254 and the rearward link mount 252. The relief regions 258 are shaped to at least partially accommodate the link stops 248 of the connecting links 226 when the track assemblies 154 are in the retracted position 154A (not shown in detail). The deployment linkage 162, the deployment lock mechanism 164, and the deployment lock release 166 may be similar to as is disclosed by U.S. Patent Publication No. 2021/0196536, the disclosure of which is hereby incorporated by reference in its entirety.

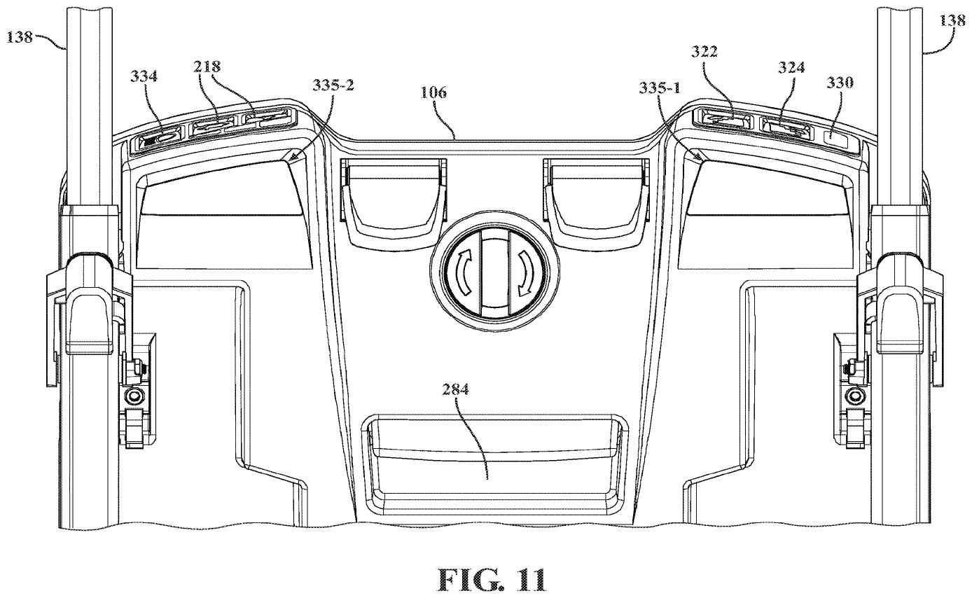

With continued reference to FIGS. 10A-10B and additional reference to FIG. 11, the patient transport apparatus 100 employs a folding lock mechanism 284 to facilitate changing between the stowed configuration FC (see FIG. 8) and the chair configuration CC (see FIG. 9A). To this end, the folding lock mechanism 284 generally comprises a folding lock release 286 operatively attached to the back section 106 and arranged for engagement by the caregiver to releasably secure the folding lock mechanism 284 between a stow lock configuration to maintain the stowed configuration FC, and a use lock configuration to prevent movement to the stowed configuration FC from the chair configuration CC or from the stair configuration SC. The folding lock mechanism 284 may incorporate features as disclosed in U.S. Pat. No. 6,648,343 previously incorporated by reference and as disclosed in U.S. Patent Publication No. 2021/0196536, previously incorporated by reference.

The drive system 182 may include various components not specifically illustrated or be configured in various ways not discussed in detail but described in U.S. Patent Publication No. 2021/0196536, previously referenced and incorporated by reference. In a version, the motor 188 may be supported on an adjustable platform that is movable relative to the drive frame 184 to adjust slack in the endless chain. This arrangement helps to optimize power density and minimize weight in the drive system 182. It will be appreciated that this arrangement could be utilized with other types of geartrains 192, such as where a belt drive (not shown) would replace the endless chain 198. Other configurations are contemplated.

In some versions, the geartrain 192 may be configured with a direct drive gearbox coupled to one of the rails 168 of the track assembly 154. Here, the drive axle 190 extends through the direct drive gearbox, and the motor 188 may be coupled to the direct drive gearbox. In some versions, the patient transport apparatus 100 may include a “passive brake” that allows the speed of the patient transport apparatus 100 to be controlled when on stairs ST even when the battery 206 is of low charge, dead, or not connected to the drive system 182 (e.g., inadvertently removed).

FIGS. 12A-12F successively depict exemplary steps of transporting a patient supported on the patient transport apparatus 100 down the stairs ST. In FIG. 12A, a first caregiver is shown engaging the pivoting handle assemblies 130 in the engagement position 130B to illustrate approaching stairs ST while the patient transport apparatus 100 is moved along floor surfaces FS in the chair configuration CC. In FIG. 12B, the patient transport apparatus 100 has been moved closer to the stairs with a second caregiver engaging the front handle assemblies 128 after having moved them to the extended position 128B. The deployment lock release 166 was also deployed by the first caregiver to move the patient transport apparatus 100 into the stair configuration SC as shown. As shown in the stair configuration SC, the track assemblies 154 are arranged in the deployed position 154B. Here, the rear wheels 152 are positioned significantly closer to the front wheels 122 compared to operation in the chair configuration CC, and are also arranged further under the seat section 104. It will be appreciated that transitioning the patient transport apparatus 100 from the chair configuration CC to the stair configuration SC has resulted in minimal patient movement relative to the support structure 102 as the carrier assembly 148 pivots about the hub axis HA and moves the rear wheels 152 closer to the front wheels 122 in response to movement of the track assemblies 154 to the deployed position 154B.

Furthermore, while the arrangement of the patient's center of gravity has not changed significantly relative to the support structure 102, the longitudinal distance which extends between the patient's center of gravity and the location at which the rear wheels 152 contact the floor surface FS has shortened considerably. Because of this, the process of “tilting” the patient transport apparatus 100 (e.g., about the rear wheels 152) to transition toward contact between the track assemblies 154 and the stairs ST, as depicted in FIG. 12C, is significantly more comfortable for the patient than would otherwise be the case if the patient transport apparatus 100 were “tilted” about the rear wheels 152 from the chair configuration CC (e.g., with the rear wheels 152 positioned further away from the front wheels 122). Put differently, the arrangement depicted in FIG. 12C is such that the patient is much less likely to feel uncomfortable, unstable, or as if they are “falling backwards” during the “tilting” process. Here too, the caregivers are afforded with similar advantages in handling the patient transport apparatus 100, as the arrangement of the rear wheel 152 described above also makes the “tilting” process easier to control and execute. In FIG. 12D, the caregivers are shown continuing to support the patient transport apparatus 100 in the stair configuration SC as the belts 156 of the track assemblies 154 are brought into contact with the edge of the top stair ST.

In FIGS. 12E and 12F, the caregivers are shown continuing to support the patient transport apparatus 100 in the stair configuration SC as the belts 156 of the track assemblies 154 contact multiple stairs ST during descent The patient transport apparatus 100 is configured to operate in a variety of states and modes in certain versions, including for example in or between one or more inactive states SI and/or one or more active states SA. During the inactive state SI, power consumption of the patient transport apparatus 100 is limited as the motor is not controlling movement of the belt during this state, and during the active state SA the controller 212 may be utilized to control movement of the belt 156 with the motor 188 of the patient transport apparatus 100.

It will be appreciated that the controller 212 may be configured to operate in a variety of inactive states SI and active states SA. The controller 212 may be configured to operate in (or between) a sleep mode MS of the inactive state SI and an active mode MS of the inactive state SI. The controller 212 may also operate in a variety of inactive states, for example, a low charge mode MLC of the inactive state SI, and/or a battery disconnect mode MBD of the inactive state SI which are discussed in detail in U.S. Patent Publication No. 2021/0196539, the disclosure of which is hereby incorporated by reference in its entirety.

During the sleep mode MS of the inactive state SI, power consumption of the patient transport apparatus 100 is limited. In some versions, power consumption of the patient transport apparatus 100 may be limited by only allowing the controller 212 to provide power from the battery 206 to certain components of the patient transport apparatus 100. For example, during the sleep mode MS, the controller 212 may be unable to generate and transmit control signals to some of the one or more powered devices, or components thereof, to drive the patient transport apparatus 100. Here, however, the controller 212 may be configured to provide power to the user interface 204. In the sleep mode MS, the user interface 204 may be prevented from emitting light, but may be configured to receive input generate by user engagement of any portion of the user interface 204. Additionally, in some instances of the sleep mode MS, one or more of the controller 212, the motor 188, the geartrain 192, and/or the track assemblies 154 may also be configured to “brake” or otherwise prevent movement of the belts 156.

During active mode MA of the inactive state, the controller 212 may not limit power consumption of any component of the patient transport apparatus 100. For example, the user interface 204 may emit light for a predetermined period of time in response to user engagement of one of the input controls 214, 216, 218, 222, 224, 322, 324, 326, 328, and 334. Various other components of the patient transport apparatus 100 may be provided power upon demand without limitation during the active mode MA of the inactive state SI.

The controller 212 may be configured to operate in a drive mode MD during the active state SA to control a direction of movement of the belt 156. In some versions, the controller 212 may be configured to additionally operate in additional modes to the drive mode during the active state SA such as a hold mode MH of the active state SA for limiting movement of the belt 156 to facilitate a controlled descent of the patient transport apparatus 100 along stairs ST. The hold mode is disclosed by the discussed in detail in U.S. Patent Publication No. 2021/0196539, previously incorporated by reference.

In some versions, the user interface 204 may comprise one or more light modules 210 realized as backlight modules 338 arranged to illuminate various input controls 214, 216, 218, 222, 224, 322, 324, 326, 328, 334 and/or indicators 220, 330, 32 under certain operating conditions. In some versions, the user interface 204 may comprise one or more light modules 210 configured to, among other things, provide status information to the caregiver.

In the representative version illustrated herein, the controller 212 may be operable in sleep mode in which power consumption is limited, and the active mode SA in which power consumption is not limited such as when the controller 212 controls movement of the belt 156 with the motor 188 of the patient transport apparatus 100. As previously described, the controller 212 may be configured to operate in a variety of other modes/states not explicitly discussed herewith but discussed in greater detail in U.S. Patent Publication No. 2021/0196539, previously incorporated by reference.

As noted above, the direction input controls 216 may include the first direction input control 322 and the second direction input control 324. Here, the first direction input control 322 may be configured to select a drive direction of the motor 188 in order to ascend stairs. The second direction input control 324 may be configured to select a drive direction of the motor 188 in order to descend stairs.

The one or more speed input controls 218 may be configured to select between the plurality of drive speeds DS1, DS2, DS3 of the motor 188. The speed indicator 332 may be disposed adjacent to the one or more speed input controls 218. The speed indicator 332 may be configured to display the selected one of the plurality of drive speeds DS1, DS2, DS3 of the motor 188 to the user.

The plurality of drive speeds DS1, DS2, DS3 may correspond to predetermined speed settings (a specific RPM setting) stored in memory of the controller 212. The plurality of drive speeds DS1, DS2, DS3 may include a first drive speed DS1, a second drive speed DS2, and a third drive speed DS3. The first drive speed DS1 corresponds to the lowest of the plurality of drive speeds DS1, DS2, DS3. The third drive speed DS3 corresponds to the highest drive speed of the plurality of drive speeds DS1, DS2, DS3. The second drive speed DS2 corresponds to a speed in between the first drive speed DS1 and the third drive speed DS3. It will be appreciated that the forgoing are non-limiting, illustrative examples of three discreet drive speeds, and other configurations are contemplated, including without limitation additional and/or fewer drive speeds, drive speeds defined in other ways, and the like.

As noted above, the one or more speed input controls 218 may include a first speed input control 326 and a second speed input control 328. The controller 212 may be configured to increase the selected speed to the next higher drive speed setting in response to the user engagement of the first speed input control 326. For example, in response to receiving user input generated by user engagement of the first speed input control 326 when the current selected drive speed is the first drive speed DS1, the controller 212 may set the current speed to the second drive speed DS2. The controller 212 may be configured to decrease the selected drive speed to the next lower drive speed setting in response to user engagement of the second speed input control 328. For example, when the current selected drive speed is the second drive speed DS2, the controller 212 may set the current speed to the first drive speed DS1 in response to user engagement of the second speed input control 328.

In some versions, the controller 212 may be configured to initially select the first drive speed DS1 of the plurality of drive speeds DS1, DS2, DS3 in response to user engagement of the direction input controls 216 following the change in operation from the inactive state SI to the active state SA. However, it is contemplated that the controller 212 may be configured alternatively, such as to initially select the second drive speed DS2 or the third drive speed DS3 of the plurality of drive speeds DS1, DS2, DS3.

The controller 212 may be configured to selectively permit operation of the motor 188 in response to receiving user input generated by engagement of one of the activation input controls 214 (e.g., the first activation input control 222 or the second activation input control 224). For example, the controller 212 may be configured to permit operation of the motor 188 in response to user engagement of at least one of the activation input controls 214 following user engagement of the direction input control 216 to drive the belt 156 in a selected drive direction. In another example, the controller 212 may be configured to permit operation of the motor 188 in response to user engagement of the activation input controls 214 within a predetermined period following engagement of the direction input control 216. After the predetermined period following user engagement of the direction input control 216 has elapsed, the controller 212 may prevent operation of the motor 188 even when one of the activation input controls 214 is engaged. The controller 212 may also be configured to limit operation of the motor 188 in response to receiving the user input before receiving the user input generated by user selection of one of the direction input controls 216.

With renewed reference to FIG. 1, the loading system 400 is shown adjacent to one of the storage compartments 54 of the transport vehicle 50 for storing the patient transport apparatus 100 within the corresponding cargo volume 56. The loading device 402 is shown coupled to the transport vehicle 50 and configured to move between a first position within the storage compartment 54 and a second position extending out of the storage compartment 54. The loading device 402 supports the patient transport apparatus 100 and facilitates loading the patient transport apparatus 100 into and out of the storage compartment 54 during operation. Extension of the loading device 402 may be manual, wherein a caregiver manually moves the loading device 402 between the first and second positions. Alternatively, the loading device 402 may comprise a powered actuator (not shown) that extends or retracts the loading device 402 between the first and second positions. Further, the loading device 402 may be mechanically linked to a door 58 of the storage compartment 54, such that opening the door 58 automatically moves the loading device 402 from the first position to the second position and closing the door 58 of the storage compartment 54 automatically moves the loading device 402 from the second position to the first position.

The loading device 402 may be slidably coupled to the transport vehicle 50 using one or more slide arms 404. The slide arms 404 may include a first portion that is fixedly coupled to the transport vehicle 50 within the cargo volume 56, and a second portion that is coupled to the loading device 402 and movable relative to the first portion. In some implementations the slide arms 404 may be implemented as a ball-bearing slide assembly. In other implementations the slide arms 404 may be implemented as telescopic slides that collapse within each other to increase and decrease length. While the door 58 illustrated in FIG. 1 is shown as a hinged door, it is contemplated that the door could be coupled to the loading device 402 such that when the loading device 402 is in the first position the door is closed, and when the loading device 402 is in the second position the door is open.

The loading device 402 may include a storage frame 406 extending between a first end 408 and a second end 410 along a loading axis 412. As used herein, the first end 408 is arranged above the second end 410 and, as such, the first end 408 may be considered as a top end and the second end 410 may be considered a bottom end, with the bottom end being nearer to the ground than the top end. The storage frame 406 further includes a loading surface 414, generally extending between the first end 408 and the second end 410. Here, the loading surface 414 is one side of the storage frame 406 that, as will be discussed in further detail below, is configured to receive the patient transport apparatus 100.

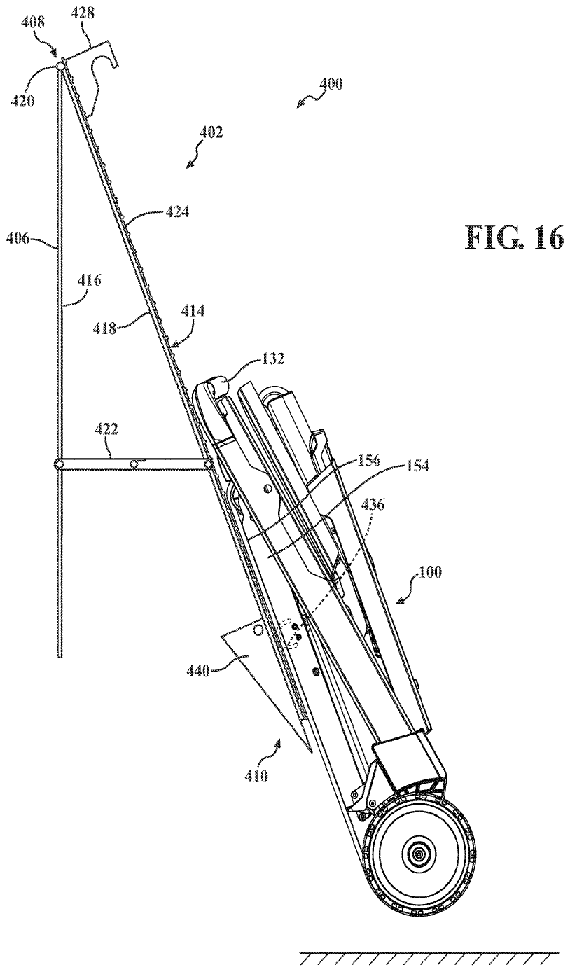

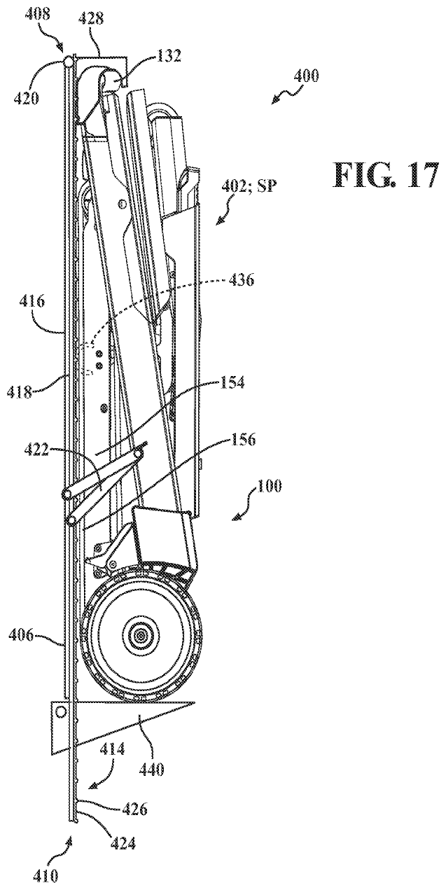

As shown in FIGS. 1 and 13-19, one implementation of the loading device 402 may include storage frame 406 having a first frame member 416 and a second frame member 418. The first frame member 416 may be coupled to the transport vehicle 50 by way of the slide arms 404 and the second frame member 418 may be movably coupled to the first frame member 416 proximate to the first end 408. More specifically, the storage frame 406 may further include a hinge 420 coupled to the first end 408 of the first frame member 416 and the second frame member 418 so as to facilitate pivoting movement of the second frame member 418 relative to the first frame member 416 and the transport vehicle 50. Best illustrated in FIGS. 16 and 17, the loading device 402 is shown in two positions, a loading position LP, and a storage position SP. In FIG. 16, the loading device 402 is shown in the loading position LP and in FIG. 17 the loading device 402 is shown in the storage position SP. In the loading position LP the second end 410 of the second frame member 418 is pivoted away from the first frame member 416 to position the loading surface 414 at an angle relative to the first frame member 416. Said differently, the loading axis 412 is substantially vertical in the storage position SP, and the loading axis 412 is angled away from vertical in the loading position LP. Conversely, in the storage position SP the second end 410 of the second frame member 418 is adjacent to the first frame member 416 to position the loading surface 414 approximately parallel to the first frame member 416. In order to define the loading position LP and the storage position SP, the loading device 402 may comprise a support brace 422 coupled between the first frame member 416 and the second frame member 418. The support brace 422 may limit the distance that the second frame member 418 can pivot away from the first frame member 416 to define the loading position LP. The support brace 422 may further secure the second frame member 418 in the loading position LP to prevent unintended movement toward the storage position. In some implementations (not shown) the support brace may include a powered actuator that moves the loading device 402 between the storage position SP and the loading position LP using energy provided by the transport vehicle 50. Similarly, the support brace may be operably coupled to the storage frame 406 and the transport vehicle 50 via a linkage such that moving the loading device 402 from the first position to the second position causes corresponding movement of the loading device from the storage position SP to the loading position LP.

The storage frame 406 may be constructed from a lightweight polymer material such as nylon. The polymer material may include a fill material such as glass fiber or carbon fiber to reinforce the storage frame 406 and increase the stiffness and resist bending. Such examples of the storage frame 406 may be formed using an injection molding process to form the storage frame 406. In another implementation, the storage frame may be formed from a composite material, such as carbon fiber, fiberglass, aramid, and combinations thereof. Alternatively, the storage frame 406 may be constructed from a metal such as aluminum, titanium, steel, or magnesium using a casting process, or using a fabrication process such as welding or fasteners.

The loading device 402 may further include a traction member 424 arranged on the loading surface 414 for engagement with the patient transport apparatus 100. In one exemplary implementation the traction member 424 may be a pair of elongated strips coupled to the loading surface 414 and arranged extending parallel to the loading axis 412. The traction member 424 increases the friction between the belt(s) 156 of the track assembly 154 when the patient transport apparatus 100 is arranged on the loading device 402. Increased friction prevents the patient transport apparatus 100 from unintended lowering by preventing the belt(s) 156 from slipping relative to the storage frame 406. Friction and/or traction between the belt(s) 156 and the traction member 424 may be increased by optimizing the material of the traction member 424 and/or the shape. As illustrated herein, the traction member 424 includes ridges 426 that may interlock with the belt(s) 156 of the track assembly 154 to facilitate positive engagement between the traction member 424 and the belt 156 of the track assembly 154 to prevent slipping. Alternatively, or in addition, to the ridges 426 the traction member 424 may be formed from a rubber material with a high coefficient of friction. Similarly, the ridges 426 may be formed from a rubber material that has been molded on to the traction member 424 or may be attached by other methods. Other materials and shapes of the traction member 424 and the ridges 426 are also contemplated.

The loading device 402 may further comprise a latch assembly 428 coupled to the storage frame 406. The latch assembly 428 is arranged adjacent to the first end 408 of the storage frame 406 and configured for releasable engagement with the handle assembly 132 of the patient transport apparatus 100, as will be discussed in further detail below. The latch assembly 428 may be actuatable by a caregiver to move between an unlatched configuration, in which the handle assembly 132 can be removed from the latch assembly 428, and a latched configuration, in which the handle assembly 132 is retained in the latch assembly 428. In some implementations the latch assembly 428 may be spring biased toward the latched configuration and such that the latch assembly 428 automatically returns to the latched configuration from the unlatched configuration. The latch assembly 428 may be operated by first engaging the handle assembly 132 with latch assembly 428 and urging the handle assembly 132 into the latch assembly 428 such that the handle assembly 132 is retained in engagement with the upper portion of the storage frame 406.

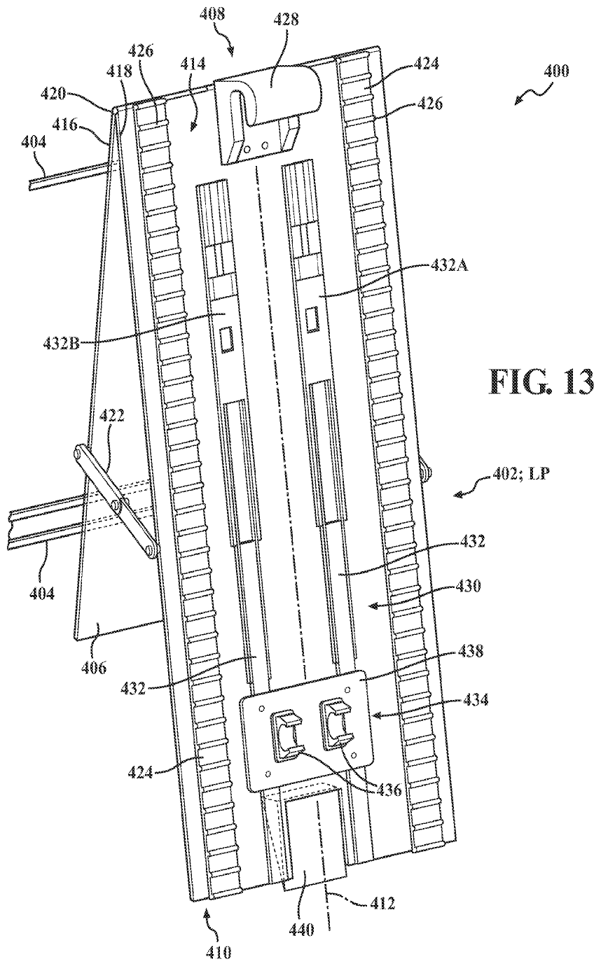

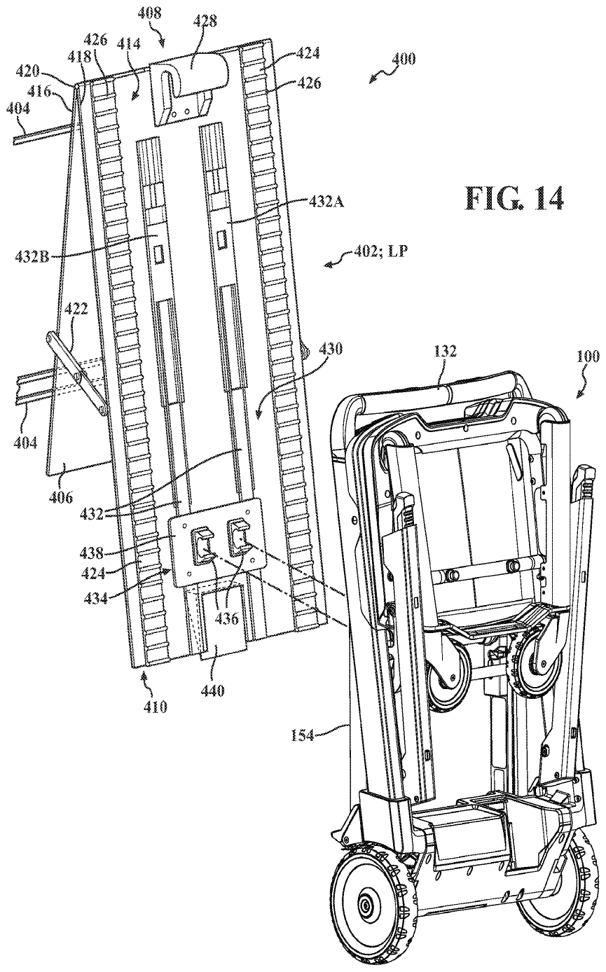

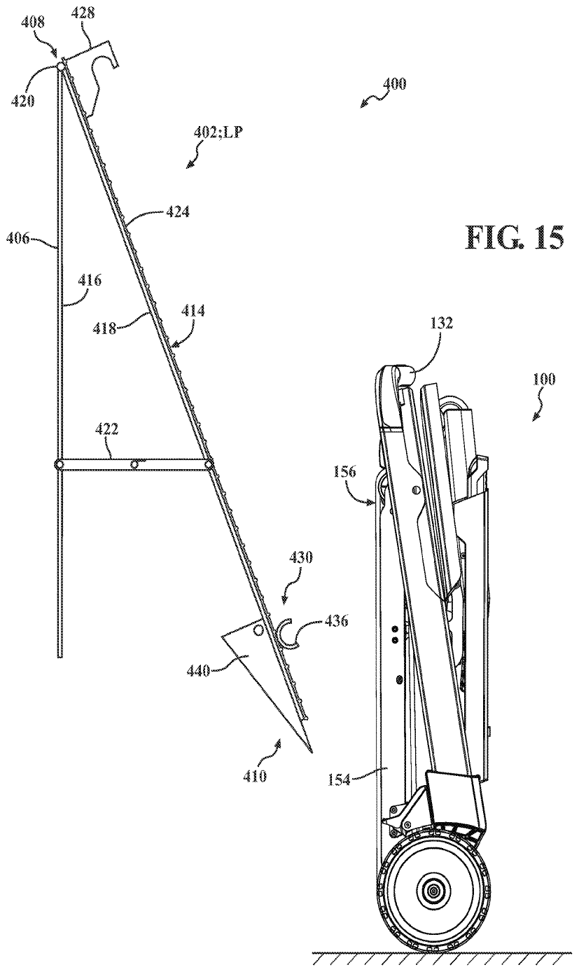

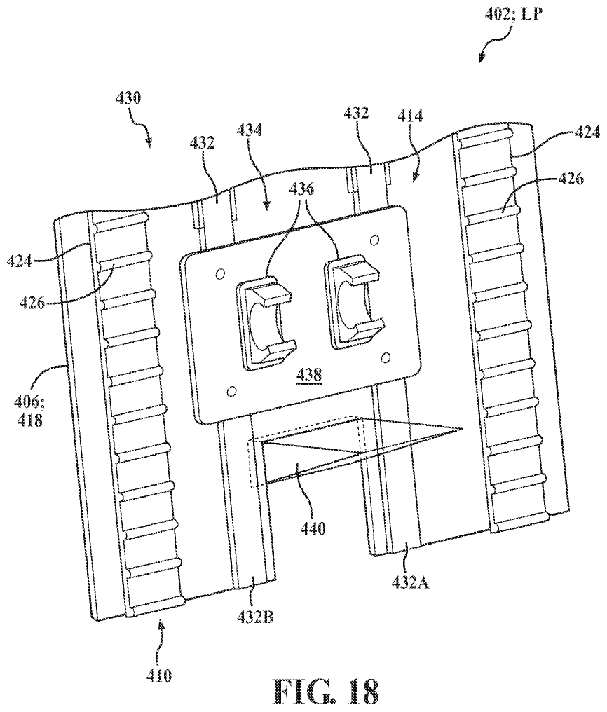

In order to further increase the traction between the traction member 424 and the track assembly 154, the loading device may further include a guide assembly 430 coupled to the storage frame 406 and arranged for engagement with the patient transport apparatus 100. Engagement between the patient transport apparatus 100 and the guide assembly 430 urges the track assembly 154 toward the traction member 424 as the patient transport apparatus 100 moves toward the first end 408 of the storage frame 406. A first exemplary implementation of the guide assembly 430 is best illustrated in FIGS. 13 and 18, which includes a first guide rail 432A and a second guide rail 432B (collectively the guide rails 432), and a trolley 434 slidably coupled to the guide rails 432. Similar to the slide arms 404 discussed above, the guide rails 432 may include a first portion that is fixedly coupled to the storage frame 406 adjacent to the loading surface 414, and a second portion that is coupled to the trolley 434 and movable relative to the first portion. In some implementations the guide rails 432 may be implemented as a ball-bearing slide assembly or a linear rail. The guide rails 432 facilitate movement of the trolley 434, which is coupled to the first guide rail 432A and the second guide rail 432B and is movable between a raised configuration (FIG. 17) and a lowered configuration (FIGS. 14 and 15).

The trolley 434 may include one or more clamp elements 436 and a cross plate 438. The cross plate 438 is coupled to the second portion of each of the coupled to first guide rail 432A and the second guide rail 432B and supports the clamp elements 436, which are coupled to the cross plate 438. The trolley 434 of the guide assembly 430 is releasably coupled to the patient transport apparatus 100 to support movement of the patient transport apparatus 100 between the loading position LP and the storage position SP. More specifically, the lowered configuration of the trolley 434 corresponds to the loading position LP of the loading device 402 and the raised configuration of the trolley 434 corresponds to the storage position of the loading device 402. The clamp elements 436 releasably couple to the cross brace 173 of the patient transport apparatus 100 to urge the track assembly 154 into engagement with the traction member 424. Here, an exemplary implementation of the clamp elements 436 are shown as a pair of resiliently flexible arms arranged to form a semi-circular cavity sized to receive the cylindrical cross brace 173. The clamp elements 436 allow a care giver to easily engage the patient transport apparatus 100 with the loading device 402 to load the patient transport apparatus 100 into the transport vehicle 50. Likewise, the clamp elements 436 allow a care giver to easily disengage the patient transport apparatus 100 from the loading device 402 to unload the patient transport apparatus 100 into the transport vehicle 50. In general, the clamp elements 436 as illustrated require a greater force to disengage the patient transport apparatus 100 than a normal force required between the belt 156 and the traction member 424 to move the patient transport apparatus 100 toward the first end 408 of the storage frame 406.

Some implementations of the loading device 402 may further include a shelf 440 moveably coupled to the storage frame 406 for supporting the patient transport apparatus 100. The shelf 440 may be configured to receive the patient transport apparatus 100 when the trolley is in the raised configuration to brace the patient transport apparatus 100 when stowed. The shelf 440 may be shaped with an inverse or opposite profile of a lower portion of the patient transport apparatus 100 to receive the patient transport apparatus 100 in a nesting manner so as to cradle the patient transport apparatus 100 and prevent substantial movement when the transport vehicle 50 is in motion. To engage the patient transport apparatus 100 with the shelf 440, the patient transport apparatus 100 is first lifted to a height such that the lower portion of the patient transport apparatus 100 is above the shelf 440, and subsequently lowered onto the shelf 440. The shelf 440 supports the weight of the patient transport apparatus 100, which prevents the patient transport apparatus 100 from unintended lowering while stowed. Here, the shelf 440 may be selectively deployable having a retracted position and an extended position. In the retracted position (FIG. 13) the shelf 440 is flush with the loading surface 414 and in the extended position (FIGS. 17 and 18) the shelf 440 is pivoted to a position protruding from the loading surface 414 to support the patient transport apparatus 100.

Turning now to FIGS. 14-17, various stages of operation of the loading system 400 are shown. Specifically, FIGS. 13-15 show the loading device 402 in the loading position LP, FIG. 16 shows the loading device 402 in an intermediate position between the loading position LP and the storage position SP, and FIG. 17 shows the loading device 402 in the storage position SP. In FIGS. 14 and 15, the patient transport apparatus 100 is arranged with the track assembly 154 adjacent to and facing the loading device 402 in preparation for coupling the patient transport apparatus 100 to the loading device 402 for storage in the transport vehicle 50. The patient transport apparatus 100 is shown in the stowed configuration FC.

Turning to FIG. 16, the patient transport apparatus 100 has been coupled to the loading device 402 with the cross brace 173 engaged with the clamp element 436. Operation of the loading system 400 is powered by the engagement between the traction member 424 and the track assembly 154. Specifically, the traction member 424 directly contact the belts 156 of the track assembly 154 for corresponding movement therewith. Operation of the track assembly 154 in a first direction causes movement of the belts 156, which in turn move in a first direction on the traction member 424 and along the loading surface 414. Likewise, operation of the track assembly 154 in a second direction causes movement of the belts 156, which in turn move in a second direction on the traction member 424 and along the loading surface 414. As is described above, operation of the track assembly 154 is powered by the motor 188, which uses electrical energy stored the battery 206 to create torque capable of rotating the drive pulley 174 to move the belts 156. When engaged with the traction member 424, this powered operation of the track assembly 154 is used to move the loading device 402 between the loading position LP and the storage position SP, which correspondingly lifts and lowers the trolley 434, and in turn the patient transport apparatus 100. Said differently, the motor 188 and track assembly 154 are utilized to effect powered loading of the patient transport apparatus 100 into the transport vehicle 50.

Operation of the loading system 400 may be controlled by the caregiver, such as with the user interface 204 arranged on the patient transport apparatus 100. For example, one or more of the activation input controls 214, the direction input controls, and the speed input controls 218 may be actuated by the caregiver to enable a loading mode of the controller 212. The loading mode may utilize the controls described above to operate the patient transport apparatus 100 similarly to operation on stairs. Alternatively, the loading mode may be specially implemented so as to only be accessible when the patient transport apparatus 100 is in the stowed configuration FC. For example, when the patient transport apparatus 100 is in the stair configuration SC, the user interface 204 functions as described above and when the patient transport apparatus 100 is in the stowed configuration FC the loading mode is enabled and the user interface 204 is changed to simplify operation of the patient transport apparatus 100. Changes to the user interface 204 may include which controls operate a particular function; the activation input controls 214 positioned on the top of the handle assembly 132 may be reconfigured to control the motor 188 and track assemblies 154 to effect lifting and lowering of the loading device 402. It is contemplated that caregiver selection or adjustment of speed as well as activation/deactivation of the motor 188 may be eliminated in the loading mode. Said differently, the controller 212 may be configured to only permit operation of the motor 188 when the appropriate user control 204 is being held (i.e., a momentary switch), and because the patient transport apparatus 100 is unoccupied and has a known weight adjustment of the lifting speed may be unnecessary.

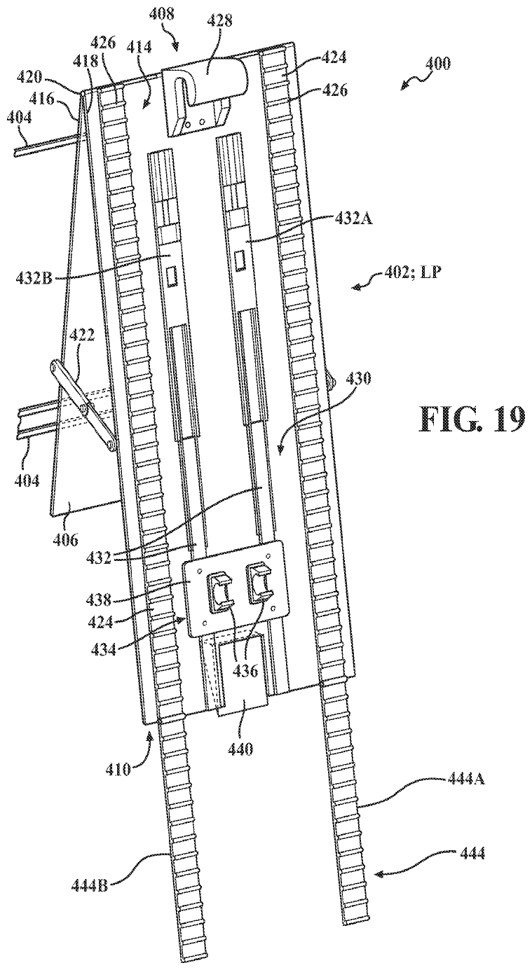

As is shown in FIGS. 1 and 19, the loading device 402 may include a traction ramp 444 in some implementations. The traction ramp 444 may be coupled to the second end 410 of the storage frame 406 adjacent to the traction member 424 and extending away from the storage frame 406. The traction ramp 444 may be removably coupled to allow a caregiver to install and remove the traction ramp 444 as necessary. For example, in ordinary operation engagement between the traction member 424 and the belt 156 may be sufficient for the patient transport apparatus 100 to climb up the loading surface 414. However, in certain situations such as if the transport vehicle 50 is parked on an inclined surface or if the traction member 424 has become wet, the engagement between the traction member 424 and the belt 156 may not be sufficient. The traction ramps 444 may further be desirable to increase compatibility with various models of stair chairs or if the belts 156 have become worn from use. In these scenarios the caregiver may attach the traction ramps 444 to the storage frame 406 to increase engagement with the belt 156. It is contemplated that the traction ramps 444 may also be movably coupled so as to be moveable between a folded position and an extended position. Movably coupling the traction ramps 444 facilitates quick and simple access by the caregiver when needed without necessitating stepping away from the loading operation to fetch the traction ramps 444.

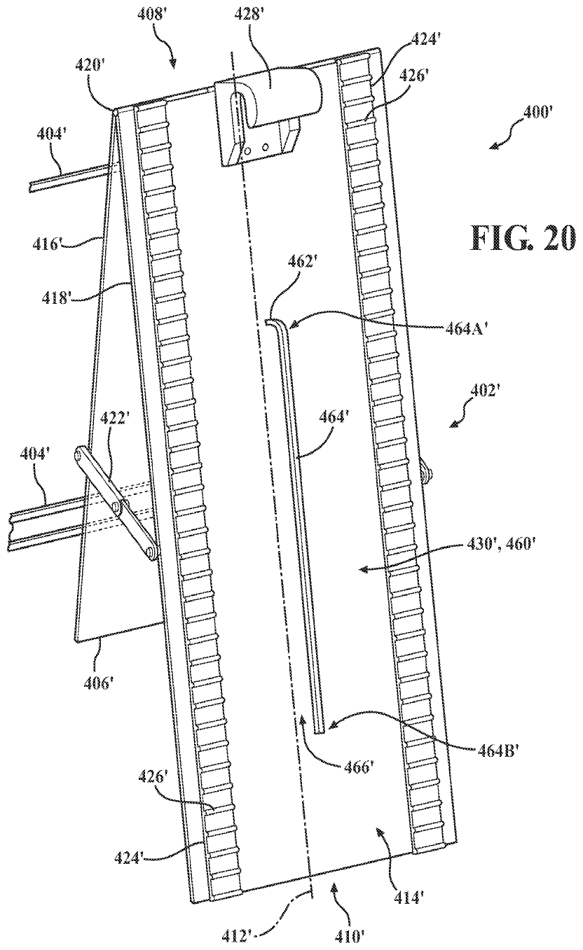

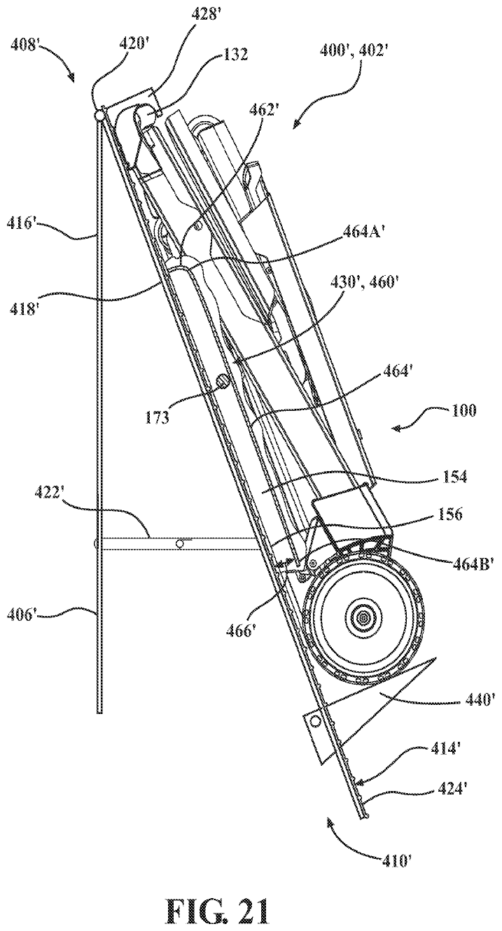

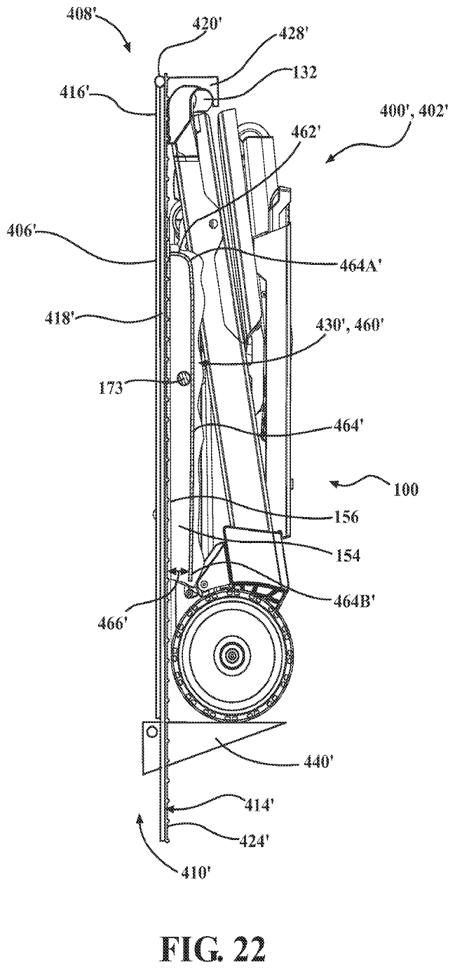

Turning now to FIGS. 20-22, a second implementation of the loading system 400′ is shown. As will be appreciated from the subsequent description below, the second implementation of the loading system 400′ is similar to the loading system 400 described above in connection with FIGS. 13-19. As such, the components and structural features of the second implementation of the loading system 400′ that are the same as, or that otherwise correspond to, the first implementation of the loading system 400 are provided with the same reference numerals with the addition of a prime symbol (e.g., 400 and 400′). While the specific differences between these implementations will be described in detail, for the purposes of clarity, consistency, and brevity, only certain structural features and components common between these versions will be discussed and depicted in the drawings of the second implementation of the loading system 400′. Here, unless otherwise indicated, the above description of the first implementation of the loading system 400 may be incorporated by reference with respect to the second implementation of the loading system 400′ without limitation.

The second implementation of the loading system 400′ shown here may include the loading device 402′, the storage frame 406′, and the guide assembly 430′. The storage frame 406′ may be coupled to the transport vehicle 50 by way of the slide arms 404′, which are substantially similar to the slide arms 404 described above. The guide assembly 430′ is coupled to the storage frame 406′ and arranged for engagement with the patient transport apparatus 100 in the storage configuration FC. The second implementation of the guide assembly 430′ may take the form of a cantilever guide 460′. The cantilever guide 460′ includes a riser portion 462′ and an elongated portion 464′ coupled to the riser portion 462′. One end of the riser portion 462′ is coupled to the loading surface 414′ with the elongated portion 464′ arranged at an opposite end of the riser portion 462′ and oriented generally parallel with the loading axis 412′ of the storage frame 406′.

The elongated portion 464′ extends between a first end 464A′ and a second end 464B'. As mentioned above, the first end 464A′ of the elongated portion 464′ is coupled to the riser portion 462′ and the second end 464B′ is spaced from the loading surface 414′ to define an opening 466′. The first end 464A′ of the elongated portion 464′ is arranged nearer to the first end 408′ of the storage frame 406′ and the second end 464B′ of the elongated portion 464′ is arranged nearer to the second end 410′ of the storage frame 406′. As such, the opening 466′ is nearer to the second end 410′ and opens toward the ground surface.

Similar to the guide assembly 430 described above, the guide assembly 430′ shown in FIGS. 20-22 is configured to urge the track assembly 154 toward the traction member 424′ as the patient transport apparatus 100 moves toward the first end 408′ of the storage frame 406′. The downward facing opening 466′ is spaced above the ground surface at a height approximately equal to the height of the cross brace 173 of the patient transport apparatus 100. Likewise, the width of the opening 466′ is approximately equal to the diameter of the cross brace 173. To load the patient transport apparatus 100 into the transport vehicle 50, the cross brace 173 is placed into the opening 466′ and the track assembly 154 is operated to lift the patient transport apparatus 100. As the patient transport apparatus 100 moves toward the first end 408′ of the storage frame 406′, the cross brace 173 is arranged between the elongated portion 464′ of the guide assembly 430′ and the loading surface 414′. The elongated portion 464′ exerts a force on the cross brace 173 to urge the belt 156 of the track assembly 154 into engagement with the traction member 424′ to prevent slipping therebetween. The size and shape of the elongated portion 464′ are chosen to exert a force on the cross brace 173 sufficient to prevent the belt 156 slipping when the cross brace 173 is furthest from the riser portion 462′. In other words, at the opening 466′, where the elongated portion 464′ is least capable of exerting force on the cross brace 173.

Several instances have been discussed in the foregoing description. However, the aspects discussed herein are not intended to be exhaustive or limit the disclosure to any particular form. Various modifications to these aspects will be readily apparent to those skilled in the art, and the generic principles defined herein may be applied to other aspects without departing from the scope of the disclosure. The terminology that has been used is intended to be in the nature of words of description rather than of limitation. Many modifications and variations are possible in light of the above teachings and the disclosure may be practiced otherwise than as specifically described.

The present disclosure also comprises the following clauses, with specific features laid out in dependent clauses, that may specifically be implemented as described in greater detail with reference to the configurations and drawings above.

### CLAUSES

I. A loading system for use with a transport vehicle, the loading system comprising:
a patient transport apparatus comprising:
   a support structure,
   a seat section and a back section operatively attached to the support structure for supporting a patient during transport,
   a track assembly operatively attached to the support structure and including a movable belt for engaging stairs, wherein the track assembly is arranged for selective operation between a retracted position and a deployed position where the track assembly is arranged to engage stairs, and wherein the patient transport apparatus is operable between:
      a chair configuration where the track assembly is in the retracted position for supporting the patient transport apparatus for movement along floor surfaces,
      a stair configuration where the track assembly is in the deployed position for supporting the patient transport apparatus for movement along stairs, and
      a stowed configuration,
   a motor coupled to the support structure and operably coupled to the track assembly for operating the movable belt, and
   a battery coupled to the support structure and in electrical communication with the motor; and
a loading device supported by the transport vehicle, the loading device comprising:
   a storage frame extending between a first end and a second end along a loading axis and having a loading surface,
   a traction member arranged on the loading surface for engagement with the movable belt of the track assembly of the patient transport apparatus, and
   a guide assembly coupled to the storage frame and arranged for engagement with the patient transport apparatus in the stowed configuration adjacent to the second end of the storage frame, wherein engagement between the guide assembly and the patient transport apparatus urges the movable belt of the track assembly toward the traction member as the patient transport apparatus moves toward the first end of the storage frame in response to torque generated by the motor of the patient transport apparatus.
II. The loading system of clause I, wherein the loading device is movably coupled to the transport vehicle and movable between a first position within a cargo volume of the transport vehicle and a second position protruding from the cargo volume.
III. The loading system of clause II, further comprising a slide assembly coupled between the loading device and the transport vehicle to facilitate sliding movement therebetween.
IV. The loading system of any of clauses I-III, wherein the storage frame further comprises a tilt portion pivotably coupled to the transport vehicle and movable between a loading configuration and a storage configuration, wherein the loading axis is substantially vertical in the storage configuration, and the loading axis is angled away from vertical in the loading configuration.
V. The loading system of any of clauses I-IV, wherein the track assembly is further defined as a pair of track assemblies each operably coupled to the motor.
VI. The loading system of any of clauses I-V, wherein the traction member is further defined as two traction members.
VII. The loading system of clause VI, wherein the two traction members are arranged on opposing sides of the guide assembly.
VIII. The loading system of any of clauses I-VII, further comprising a traction ramp coupled to the second end of the storage frame adjacent to the traction member and extending away from the storage frame.
IX. A loading device for supporting a patient transport apparatus in a transport vehicle, the loading device comprising:
a storage frame coupled to the transport vehicle, the storage frame extending between a first end and a second end along a loading axis and having a loading surface;
a guide assembly coupled to the storage frame and arranged adjacent to the loading surface, the guide assembly comprising:
   a guide rail extending parallel to the loading axis; and
   a trolley slidably coupled to the guide rail and movable between a raised configuration and a lowered configuration, the trolley configured to releasably engage the patient transport apparatus; and
a traction member coupled to the loading surface for engagement with a movable belt of a track assembly of the patient transport apparatus.
X. The loading device of clause IX, wherein the traction member is further defined as two traction members.
XI. The loading device of clause X, wherein the two traction members are arranged on opposing sides of the guide assembly.
XII. The loading device of any of clauses IX-XI, wherein the storage frame further comprises a tilt portion pivotably coupled to the transport vehicle and movable between a loading position and a storage position, wherein the loading axis is substantially vertical in the storage position, and the loading axis is angled away from vertical in the loading position.
XIII. A loading system comprising:
a transport vehicle;
a patient transport apparatus comprising:
   a support structure,
   a seat section and a back section operatively attached to the support structure for supporting a patient during transport,
   a track assembly operatively attached to the support structure and including a movable belt for engaging stairs, wherein the track assembly is arranged for selective operation between a retracted position and a deployed position where the track assembly is arranged to engage stairs, and wherein the patient transport apparatus is operable between:
      a chair configuration where the track assembly is in the retracted position for supporting the patient transport apparatus for movement along floor surfaces,
      a stair configuration where the track assembly is in the deployed position for supporting the patient transport apparatus for movement along stairs, and
      a stowed configuration,
   a motor coupled to the support structure and operably coupled to the track assembly for operating the movable belt, and
   a battery coupled to the support structure and in electrical communication with the motor; and
a loading device comprising:
   a storage frame coupled to the transport vehicle and extending between a first end and a second end along a loading axis and having a loading surface;
   a guide assembly coupled to the storage frame and arranged adjacent to the loading surface, the guide assembly comprising:
      a guide rail extending parallel to the loading axis; and
      a trolley slidably coupled to the guide rail and movable between a raised configuration and a lowered configuration, the trolley configured to releasably engage the patient transport apparatus in the stowed configuration; and
   a traction member coupled to the loading surface and arranged to engage the movable belt of the track assembly of the patient transport apparatus as the patient transport apparatus moves with the trolley toward the first end of the storage frame in response to torque generated by the motor of the patient transport apparatus.
XIV. The loading system of clause XIII, wherein the loading device is movably coupled to the transport vehicle and movable between a first position within a cargo volume of the transport vehicle and a second position protruding from the cargo volume.
XV. The loading system of clause XIV, further comprising a slide assembly coupled between the loading device and the transport vehicle to facilitate sliding movement therebetween.
XVI. The loading system of any of clauses XIII-XV, wherein the storage frame further comprises a tilt portion pivotably coupled to the transport vehicle and movable between a loading configuration and a storage configuration, wherein the loading axis is substantially vertical in the storage configuration, and the loading axis is angled away from vertical in the loading configuration.
XVII. The loading system of any of clauses XIII-XVI, wherein the track assembly is further defined as a pair of track assemblies each operably coupled to the motor.
XVIII. The loading system of any of clauses XIII-XVII, wherein the patient transport apparatus further comprises a controller configured to operate the motor when the patient transport apparatus is engaged with the trolley to move the trolley between the lowered configuration and the raised configuration.
XIX. The loading system of any of clauses XIII-XVIII, wherein the guide rail is further defined as a first guide rail and a second guide rail arranged on opposing side of the loading axis, and wherein the trolley is support by the first guide rail and the second guide rail.
XX. The loading system of any of clauses XIII-XIX, wherein the guide rail is a linear rail assembly.
XXI. The loading system of any of clauses XIII-XX, wherein the traction member is further defined as two traction members.
XXII. The loading system of clause XXI, wherein the two traction members are arranged on opposing sides of the guide assembly.
XXIII. The loading system of any of clauses XIII-XXII, further comprising a traction ramp coupled to the second end of the storage frame adjacent to the traction member and extending away from the storage frame.
XXIV. A loading system for use with a transport vehicle, the loading system comprising:
a patient transport apparatus comprising a powered track assembly, the patient transport apparatus being operable between a chair configuration and a stowed configuration;
a loading device supported by the transport vehicle, the loading device comprising:
   a storage frame extending between a first end and a second end along a loading axis and having a loading surface;
   a traction member arranged on the loading surface for engagement with the powered track assembly of the patient transport apparatus; and
   a guide assembly coupled to the storage frame and arranged for engagement with the patient transport apparatus in the stowed configuration adjacent to the second end of the storage frame, wherein engagement between the guide assembly and the patient transport apparatus urges the powered track assembly toward the traction member as the patient transport apparatus moves toward the first end of the storage frame.
XXV. The loading system of clause XXIV, wherein the loading device is movably coupled to the transport vehicle and movable between a first position within a cargo volume of the transport vehicle and a second position protruding from the cargo volume.
XXVI. The loading system of clause XXV, further comprising a slide assembly coupled between the loading device and the transport vehicle to facilitate sliding movement therebetween.
XXVII. The loading system of any of clauses XXIV-XXVI, wherein the storage frame further comprises a tilt portion pivotably coupled to the transport vehicle and movable between a loading configuration and a storage configuration, wherein the loading axis is substantially vertical in the storage configuration, and the loading axis is angled away from vertical in the loading configuration.
XXVIII. The loading system of any of clauses XXIV-XXVII, wherein the patient transport apparatus includes:
a motor operably coupled to the powered track assembly; and
a battery in electrical communication with the motor.
XXIX. The loading system of clause XXVIII, wherein the powered track assembly is further defined as a pair of powered track assemblies each operably coupled to the motor.
XXX. The loading system of any of clauses XXIV-XXIX, wherein the traction member is further defined as two traction members.
XXXI. The loading system of clause XXX, wherein the two traction members are arranged on opposing sides of the guide assembly.
XXXII. The loading system of any of clauses XXIV-XXXI, further comprising a traction ramp coupled to the second end of the storage frame adjacent to the traction member and extending away from the storage frame.
XXXIII. A loading device for supporting a patient transport apparatus in a transport vehicle, the loading device comprising:
a storage frame coupled to the transport vehicle, the storage frame extending between a first end and a second end along a loading axis and having a loading surface;
a guide assembly coupled to the storage frame and arranged adjacent to the loading surface, the guide assembly comprising:
   a guide rail extending parallel to the loading axis; and
   a trolley slidably coupled to the guide rail and movable between a raised configuration and a lowered configuration, the trolley configured to releasably engage the patient transport apparatus; and
a traction member coupled to the loading surface for engagement with a powered track assembly of the patient transport apparatus.
XXXIV. The loading device of clause XXXIII, wherein the traction member is further defined as two traction members.
XXXV. The loading device of clause XXXIV, wherein the two traction members are arranged on opposing sides of the guide assembly.
XXXVI. The loading device of any of clauses XXXIII-XXXV, wherein the storage frame further comprises a tilt portion pivotably coupled to the transport vehicle and movable between a loading position and a storage position, wherein the loading axis is substantially vertical in the storage position, and the loading axis is angled away from vertical in the loading position.
XXXVII. A loading system comprising:
a transport vehicle;
a patient transport apparatus comprising a powered track assembly, the patient transport apparatus being operable between a chair configuration and a stowed configuration;
a loading device comprising:
   a storage frame coupled to the transport vehicle and extending between a first end and a second end along a loading axis and having a loading surface;
   a guide assembly coupled to the storage frame and arranged adjacent to the loading surface, the guide assembly comprising:
      a guide rail extending parallel to the loading axis; and
      a trolley slidably coupled to the guide rail and movable between a raised configuration and a lowered configuration, the trolley configured to releasably engage the patient transport apparatus in the stowed configuration; and
   a traction member coupled to the loading surface and configured for engagement with the powered track assembly of the patient transport apparatus.
XXXVIII. The loading system of clause XXXVII, wherein the loading device is movably coupled to the transport vehicle and movable between a first position within a cargo volume of the transport vehicle and a second position protruding from the cargo volume.
XXXIX. The loading system of clause XXXVIII, further comprising a slide assembly coupled between the loading device and the transport vehicle to facilitate sliding movement therebetween.
XL. The loading system of any of clauses XXXVII-XXXIX, wherein the storage frame further comprises a tilt portion pivotably coupled to the transport vehicle and movable between a loading configuration and a storage configuration, wherein the loading axis is substantially vertical in the storage configuration, and the loading axis is angled away from vertical in the loading configuration.
XLI. The loading system of any of clauses XXXVII-XL, wherein the powered track assembly comprises a motor and a battery in electrical communication with the motor, and a track assembly operably coupled to the motor.
XLII. The loading system of clause XLI, wherein the track assembly is further defined as a pair of track assemblies each operably coupled to the motor.
XLIII. The loading system of any of clauses XXXVII-XLII, wherein the patient transport apparatus further comprises a motor and a controller, the controller configured to operate the powered track assembly when the patient transport apparatus is engaged with the trolley to move the trolley between the lowered configuration and the raised configuration.
XLIV. The loading system of any of clauses XXXVII-XLIII, wherein the guide rail is further defined as a first guide rail and a second guide rail arranged on opposing side of the loading axis, and wherein the trolley is support by the first guide rail and the second guide rail.
XLV. The loading system of any of clauses XXXVII-XLIV, wherein the guide rail is a linear rail assembly.
XLVI. The loading system of any of clauses XXXVII-XLV, wherein the traction member is further defined as two traction members.
XLVII. The loading system of clause XLVI, wherein the two traction members are arranged on opposing sides of the guide assembly.
XLVIII. The loading system of any of clauses XXXVII-XLVII, further comprising a traction ramp coupled to the second end of the storage frame adjacent to the traction member and extending away from the storage frame.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. A loading system for use with a transport vehicle, the loading system comprising:
a patient transport apparatus comprising a powered track assembly, the patient transport apparatus being operable between a chair configuration and a stowed configuration;
a loading device supported by the transport vehicle, the loading device comprising:
a storage frame extending between a first end and a second end along a loading axis and having a loading surface;
a traction member arranged on the loading surface for engagement with the powered track assembly of the patient transport apparatus; and
a guide assembly coupled to the storage frame and arranged for engagement with the patient transport apparatus in the stowed configuration adjacent to the second end of the storage frame, wherein engagement between the guide assembly and the patient transport apparatus urges the powered track assembly toward the traction member as the patient transport apparatus moves toward the first end of the storage frame.

25. The loading system of claim 24, wherein the loading device is movably coupled to the transport vehicle and movable between a first position within a cargo volume of the transport vehicle and a second position protruding from the cargo volume.

26. The loading system of claim 25, further comprising a slide assembly coupled between the loading device and the transport vehicle to facilitate sliding movement therebetween.

27. The loading system of claim 24, wherein the storage frame further comprises a tilt portion pivotably coupled to the transport vehicle and movable between a loading configuration and a storage configuration, wherein the loading axis is substantially vertical in the storage configuration, and the loading axis is angled away from vertical in the loading configuration.

28. The loading system of claim 24, wherein the patient transport apparatus includes:
a motor operably coupled to the powered track assembly; and
a battery in electrical communication with the motor.

29. The loading system of claim 28, wherein the powered track assembly is further defined as a pair of powered track assemblies each operably coupled to the motor.

30. The loading system of claim 24, wherein the traction member is further defined as two traction members.

31. The loading system of claim 30, wherein the two traction members are arranged on opposing sides of the guide assembly.

32. The loading system of claim 24, further comprising a traction ramp coupled to the second end of the storage frame adjacent to the traction member and extending away from the storage frame.

33. (canceled)

34. (canceled)

35. (canceled)

36. (canceled)

37. A loading system comprising:
a transport vehicle;
a patient transport apparatus comprising a powered track assembly, the patient transport apparatus being operable between a chair configuration and a stowed configuration;
a loading device comprising:
a storage frame coupled to the transport vehicle and extending between a first end and a second end along a loading axis and having a loading surface;
a guide assembly coupled to the storage frame and arranged adjacent to the loading surface, the guide assembly comprising:
a guide rail extending parallel to the loading axis; and
a trolley slidably coupled to the guide rail and movable between a raised configuration and a lowered configuration, the trolley configured to releasably engage the patient transport apparatus in the stowed configuration; and
a traction member coupled to the loading surface and configured for engagement with the powered track assembly of the patient transport apparatus.

38. The loading system of claim 37, wherein the loading device is movably coupled to the transport vehicle and movable between a first position within a cargo volume of the transport vehicle and a second position protruding from the cargo volume.

39. The loading system of claim 38, further comprising a slide assembly coupled between the loading device and the transport vehicle to facilitate sliding movement therebetween.

40. The loading system of claim 37, wherein the storage frame further comprises a tilt portion pivotably coupled to the transport vehicle and movable between a loading configuration and a storage configuration, wherein the loading axis is substantially vertical in the storage configuration, and the loading axis is angled away from vertical in the loading configuration.

41. The loading system of claim 37, wherein the powered track assembly comprises a motor and a battery in electrical communication with the motor, and a track assembly operably coupled to the motor.

42. The loading system of claim 41, wherein the track assembly is further defined as a pair of track assemblies each operably coupled to the motor.

43. The loading system of claim 37, wherein the patient transport apparatus further comprises a motor and a controller, the controller configured to operate the powered track assembly when the patient transport apparatus is engaged with the trolley to move the trolley between the lowered configuration and the raised configuration.

44. The loading system of claim 37, wherein the guide rail is further defined as a first guide rail and a second guide rail arranged on opposing side of the loading axis, and wherein the trolley is support by the first guide rail and the second guide rail.

45. The loading system of claim 37, wherein the guide rail is a linear rail assembly.

46. The loading system of claim 37, wherein the traction member is further defined as two traction members; and
wherein the two traction members are arranged on opposing sides of the guide assembly.

47. (canceled)

48. The loading system of claim 37, further comprising a traction ramp coupled to the second end of the storage frame adjacent to the traction member and extending away from the storage frame.
